(19) United States
(12) Patent Application Publication
(10) Pub. No.: US 2022/0099205 A1
(43) Pub. Date: Mar. 31, 2022

(54) PRESSURE RELIEF DEVICE

(71) Applicant: BS&B INNOVATIONS LIMITED, Limerick (IE)

(72) Inventors: Colman Casey, Limerick (IE); Damien Hennessy, Limerick (IE); Geoffrey Brazier, Woodbury, MN (US)

(73) Assignee: BS&B Innovations Limited, Limerick (IE)

(21) Appl. No.: 17/487,406

(22) Filed: Sep. 28, 2021

Related U.S. Application Data
(60) Provisional application No. 63/084,046, filed on Sep. 28, 2020.

(51) Int. Cl. F16K 17/16; F16K 27/02

(52) U.S. Cl. CPC F16K 17/1613; F16K 27/0236

(57) ABSTRACT

A pressure relief device is disclosed, such as may be used with a battery. According to one embodiment, the pressure relief device may include a pressure-retaining membrane—which may be a polymer or flexible graphite membrane—supported by a support strip. In response to a predetermined pressure on the pressure-retaining membrane, the support strip may be caused to deform, allowing the pressure-retaining membrane to open. The pressure-retaining membrane may include one or more lines of weakness to define an opening area and/or to determine the pressure conditions under which the membrane may open. One or more stress-applying devices or piercing mechanisms may be provided to cause the membrane to open.

### FIELD

This disclosure is directed to the field of pressure relief devices. More particularly, the disclosure relates to non-reclosable pressure-retaining membranes designed to open during an explosion or in response to a pre-determined pressure differential to reduce damage. Further, the disclosure relates to such membranes as may be used to provide pressure relief for automobile, other e-mobility, and non moving battery devices, such as lithium-ion battery devices.

### BACKGROUND

Electrical automobiles rely on battery devices to supply power. Typically, such battery devices include several battery cells arranged in a battery pack configuration. For safety and other reasons, a battery pack and/or individual battery cells may be provided with a pressure relief mechanism, which is designed to relieve internal pressure and avoid an uncontrolled battery or battery pack failure.

One conventional pressure relief mechanism for an automotive battery takes the form of a threaded, reclosable, spring-loaded pop valve assembly. Such assemblies suffer numerous drawbacks. For example, such assemblies may leak or provide an inaccurate response pressure, particularly in response to changes in operating temperature. Such valve assemblies also have a relatively slow response time and may provide an undesirably low flow rate upon activation. Moreover, it is difficult for such assemblies to re-seat precisely after internal battery pressure subsides. As a result, the conventional battery pop valve assembly is unable to maintain a good seal following repeated valve activations. Conventional pop battery valves, therefore, present several drawbacks when used with the lithium battery packs typically used in electric vehicles.

As an alternative to popup valve assemblies, other conventional pressure relief mechanisms for lithium battery packs use a destructible plastic membrane pressure relief device, which is designed to open in response to a temperature above the plastic membrane's melting point (typically 200° C. or higher). That conventional design requires time to transition from the initial pressure response inside the battery enclosure to opening and flow of hot battery gases once a temperature elevated above normal ambient operating conditions is reached. Another conventional design may include a membrane in the form of a flat plastic film, which is designed to bulge (in tension) as pressure increases and hit at least one puncture point outside of the battery that imparts a pinhole-type opening. Over time, that opening will expand by melting as hot gas from the battery arrives. However, while the plastic film waits to melt, the pressure in the battery pack increases and can present safety challenges, particularly under low-ambient-temperature conditions, which cause the tensile strength of a conventional simple plastic membrane to increase greatly.

In addition to the foregoing deficiencies, the activation pressure of a conventional, tension-loaded pressure relief device is dictated by the strength of the material that forms the device's plastic film. Relying on material strength to determine activation pressure, however, results in a high degree of inaccuracy and imprecision, particularly due to the wide variation in mechanical properties that occurs with plastics over the extended ambient temperature range (such as −40 deg F/−40 deg C to +150 deg F/+65 deg C) and due to the small nominal sizes common in battery applications. In addition, small nominal size pressure relief mechanisms provide a small opening area after activation, which may undesirably hinder the release of pressure.

In view of the foregoing, there exists a need for an improved pressure relief device suitable for use in low-pressure automotive, e-mobility, and static battery applications. Further, there exists a need for such a device to vent pressure more quickly, with a larger and more immediate opening, than may be achieved by conventional devices. There is also a need for an improved pressure relief device capable of meeting installation requirements for high-volume automotive and e-mobility applications. The present disclosure meets one or more of these needs, and/or provides other advantages.

### BRIEF SUMMARY

To attain one or more of the above or other advantages, as embodied and broadly described herein, the disclosure is directed to a pressure relief device comprising a pressure-retaining membrane. A support strip may be positioned adjacent to a surface of the membrane, the support strip being configured to support the membrane when the membrane is subjected to pressures from a pressurizable volume. The support strip may be configured to activate by deforming in response to a predetermined pressure acting on the membrane, and the membrane may be configured to contact a stress-applying device when the arched support strip has deformed.

The disclosure is further directed to a pressure relief device, comprising an inlet housing, a support ring having at least one support strip, and a flexible graphite membrane sealed between the inlet housing and support ring, wherein the at least one support strip provides structural support for the flexible graphite membrane. The flexible graphite membrane may be provided with a line of weakness.

In another aspect, the disclosure also is directed to a pressure relief device comprising a housing, a piercing mechanism, and a support member comprising a support strip. The piercing mechanism may be held between the housing and the support member. A membrane may be held between the support member and a protective layer, and the support strip may be configured to fail in response to a predetermined pressure imparted on the support strip via the membrane.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1A illustrates a cross-sectional view of one embodiment of a pressure relief device;

FIG. 1B illustrates another cross-sectional view of the embodiment illustrated in FIG. 1A, perpendicular to the view in FIG. 1A;

FIG. 1C illustrates an exploded component view of the embodiment illustrated in FIGS. 1A and 1B;

FIG. 2A illustrates a perspective view of another embodiment of a pressure relief device;

FIG. 2B illustrates another perspective view of the embodiment of FIG. 2A, further depicting a transparent pressure-retaining membrane;

FIG. 2C illustrates another perspective view of the embodiment of FIGS. 2A-2B, further depicting an opaque pressure-retaining membrane;

FIG. 2D illustrates a bottom perspective view of the embodiment of FIG. 2C;

FIG. 2E illustrates an exploded component view of the pressure relief device depicted in FIGS. 2A-2D;

FIGS. 3A-3B illustrate exploded views of an embodiment of a pressure relief device;

FIG. 3C illustrates a view of the top of the housing of the assembled pressure relief device of FIGS. 3A-3B;

FIG. 3D illustrates a view of the front of the housing of the assembled pressure relief device of FIGS. 3A-3B;

FIG. 3E illustrates a view of the bottom of the housing of the assembled pressure relief device of FIGS. 3A-3B;

FIG. 3F illustrates a view of the side of the housing of the assembled pressure relief device of FIGS. 3A-3B;

FIG. 3G illustrates an exploded component view of an alternative configuration of the embodiment depicted in FIGS. 3A-3B;

FIGS. 4A-4B illustrate exploded views of another embodiment of a pressure relief device;

FIG. 4C illustrates a view of the top of the housing of the assembled pressure relief device of FIGS. 4A-4B;

FIG. 4D illustrates a view of the front of the housing of the assembled pressure relief device of FIGS. 4A-4B;

FIG. 4E illustrates a view of the bottom of the housing of the assembled pressure relief device of FIGS. 4A-4B;

FIG. 4F illustrates a view of the side of the housing of the assembled pressure relief device of FIGS. 4A-4B;

FIGS. 4G-4H illustrate two exploded component views of an alternative configuration of the embodiment depicted in FIGS. 4A-4B;

FIG. 5A illustrates a perspective view of the top of an embodiment;

FIG. 5B illustrates a perspective view of the bottom of the embodiment of FIG. 5A;

FIG. 5C illustrates a cross-sectional view of the embodiment of FIG. 5A;

FIG. 6A depicts another embodiment of a pressure relief device;

FIGS. 6B-6C depict cross-sectional views of the embodiment of FIG. 6A;

FIG. 7A depicts another embodiment of a pressure relief device;

FIGS. 7B depicts a cross-sectional view of the embodiment of FIG. 7A;

FIG. 8 illustrates a perspective view of the housing, piercing mechanism, and support strip according to an embodiment;

FIG. 9 illustrates a perspective view of a housing and piercing mechanism according to another embodiment;

FIG. 10A illustrates an embodiment of a membrane having a line of weakness;

FIG. 10B illustrates another embodiment of a membrane having a line of weakness;

FIGS. 11A-11B illustrate perspective views of another embodiment of a pressure relief device;

FIGS. 11C-11D illustrate cross-sectional views of the embodiment illustrated in FIGS. 11A-11B;

FIGS. 12A-12C illustrate perspective views of another embodiment of a pressure relief device;

FIG. 12D illustrates an exploded component view of the embodiment illustrated in FIGS. 12A-12C;

FIGS. 13A-13B illustrate perspective views of a threaded support housing according to one embodiment;

FIGS. 14A-14B illustrate perspective views of a tabbed-and-grooved support housing according to another embodiment;

FIG. 15A illustrates a perspective view of a further embodiment of a pressure relief device;

FIGS. 15B-15C depict exploded views of the embodiment of FIG. 15A;

FIG. 16A illustrates a perspective view of another embodiment of a pressure relief device;

FIGS. 16B-16C depict cross-sectional views of the embodiment of FIG. 16A;

FIG. 16D depicts a detail view of the cross-section shown in FIG. 16C;

FIG. 17A is an exploded view of another embodiment of a pressure relief device having a graphite membrane; and

FIGS. 17B-17C are perspective views of the assembled device of FIG. 17A.

### DESCRIPTION OF THE EMBODIMENTS

Reference will now be made in detail to the present exemplary embodiments, examples of which are illustrated in the accompanying drawings.

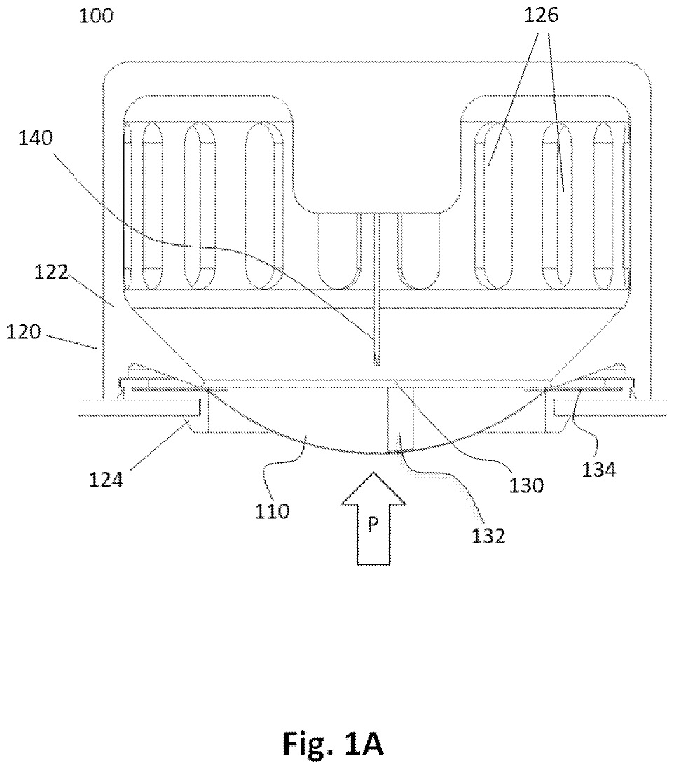

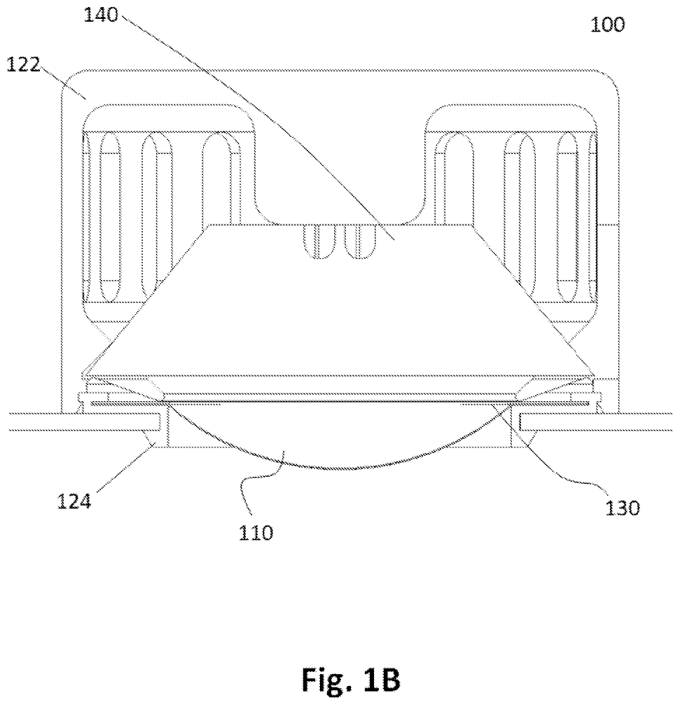

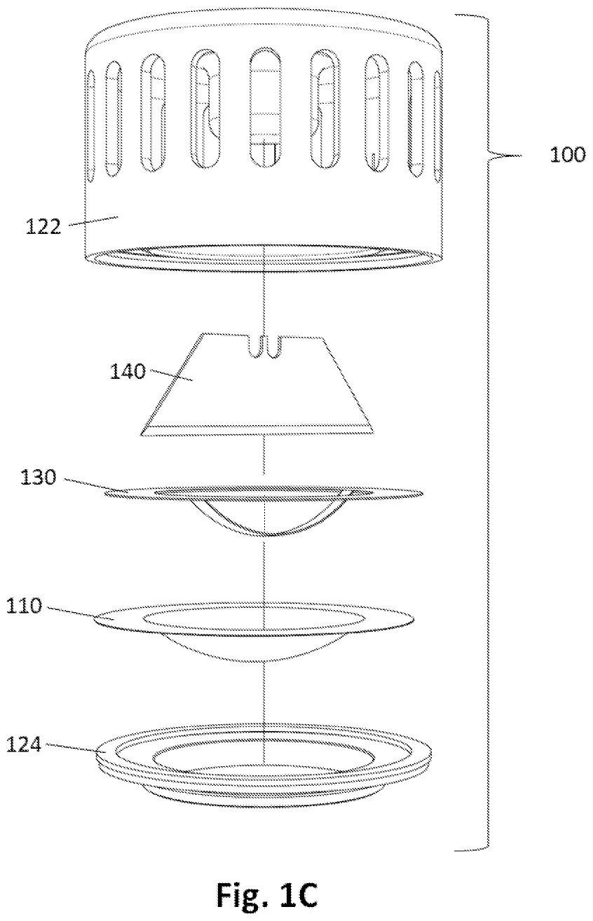

FIGS. 1A-1C illustrate an embodiment of a pressure relief device 100. As illustrated, a dome-shaped pressure-retaining membrane 110, which may be a rupture disk, is held between an outlet portion 122 and inlet portion 124 of a support housing 120. The dome-shaped membrane has a convex side and a concave side. A support member 130, having a support strip 132, is positioned on the concave side of the membrane. The support strip 132 forms an arch, which supports the membrane 110. As illustrated, the convex side of the membrane 110 is designed to face a control volume having a pressure “P.” For example, in use, the pressure relief device 100 of FIG. 1A may be installed at an opening of a battery enclosure, with the convex side of the membrane 110 facing the interior of the battery enclosure. Additional detail of the components of pressure relief device 100 are illustrated in the exploded view shown in FIG. 1C.

As illustrated in FIG. 1A, the support strip 132 is configured to set the activation pressure of the pressure relief device 100. For example, the support strip 132 may be designed with a fixed profile (e.g., thickness, length, material, shape) having a predetermined mechanical strength. Other aspects of a support strip may be modified to set an activation pressure and/or control characteristics such as response force, response pressure, and the position of flexure (e.g., the portion(s) of the strip that will deform in response to an overpressure situation and/or the extent of deformation). For example, a support strip may be provided with holes, indentations, pinch points, notches, lines of weakness, strengthening/reinforcing structure (e.g., ribs or embossments), or other features to control how, where, and under which conditions the support strip will deform and/or fail.

When pressure transmitted via the membrane 110 reaches a predetermined level (i.e., the activation pressure), the mechanical strength of the support strip 132 is overcome, causing the support strip 132 to collapse or reverse. As a result, the membrane 110 also is allowed to collapse or reverse.

Although FIGS. 1A and 1B illustrate a reverse-acting pressure relief device, in another embodiment one or more support strip(s) (e.g., 132) also may be used with a forward-acting pressure relief device. In such an embodiment, one or more support strips may be configured to deform or fail when system pressure imparts a predetermined tensile strain on the support strip, thereby allowing a seal (e.g., plastic or graphite) to open (e.g., due to tearing, contact with a piercing mechanism, etc.) and release pressure from the system. In such an embodiment, the support strip(s) may be configured to spring out of a first position without breaking (e.g., in the manner of a spring or a Belleville washer). In other embodiments, the support strip(s) may be formed integrally with a support body (as discussed below), provided as a modular plastic or metal component retained at each end to a support body (e.g., via welding or mechanical fastener), and/or provided as a metal or plastic component having at least one feature (e.g., a hole, notch, indentation, or weakened area) configured to set burst pressure.

FIGS. 1A and 1B further illustrate a stress applying device, in the form of piercing mechanism 140, positioned on the concave side (i.e., downstream side) of the pressure-retaining membrane 110. When the support strip 132 collapses or reverses, system pressure will force the membrane 110 into contact with the piercing mechanism 140, which will pierce the membrane 110. Piercing the membrane 110 will relieve pressure, thereby preventing a potentially dangerous overpressure situation. As illustrated, the piercing mechanism 140 is a separate or integral component (e.g., a blade, pointed fastener, or any other such device that may impinge upon a membrane to impart an opening stress) that is mounted or integral within the housing 120, with its piercing element directed toward the pressure-retaining membrane 110. The piercing mechanism 140 may be a modular component, which may be replaced by the manufacturer or other operator as needed or desired. In an embodiment using a modular piercing mechanism 140, the piercing mechanism(s) 140 may be selected to optimize performance for a given application. For example, a low flow requirement may only need a small opening created, while a high flow requirement may need a larger opening. The piercing mechanism may be selected accordingly with more than one being applied, or being circular or other non-linear shape.

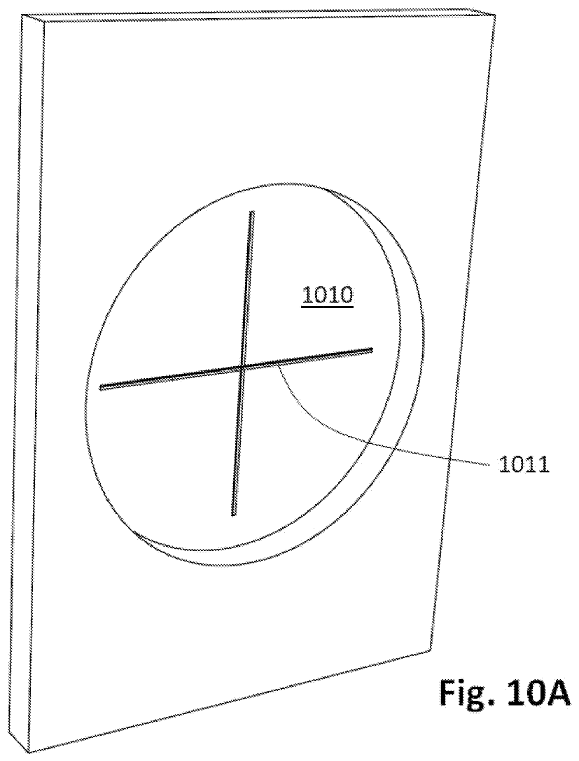

The piercing mechanism may be integrated into the housing, including being constructed from the same material as one of the housing components. In one embodiment, the piercing mechanism and housing component may be produced together as one piece. In an alternative embodiment, illustrated for example in FIGS. 8 and 9, a piercing mechanism 840, 940 is directly incorporated into the housing 820, 920. As illustrated, an injection-molded housing may include a conical, injection-molded point configured to be directed toward the pressure-retaining membrane.

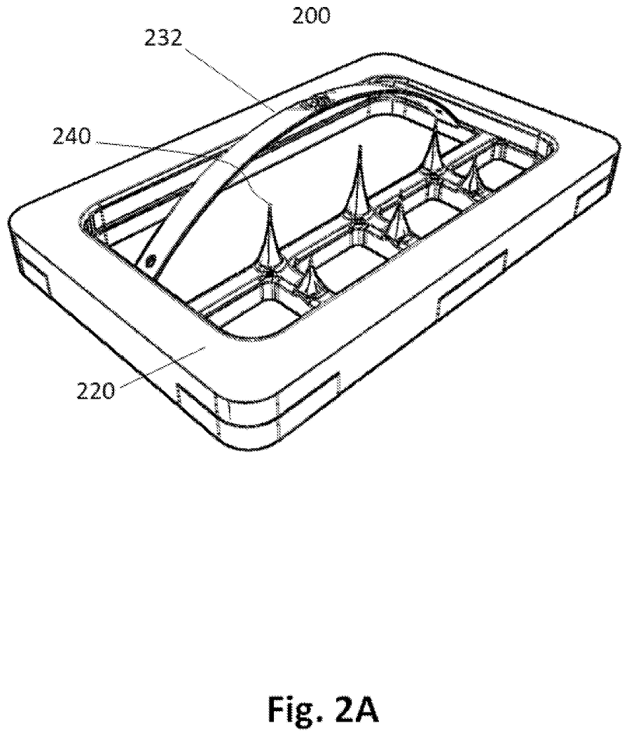

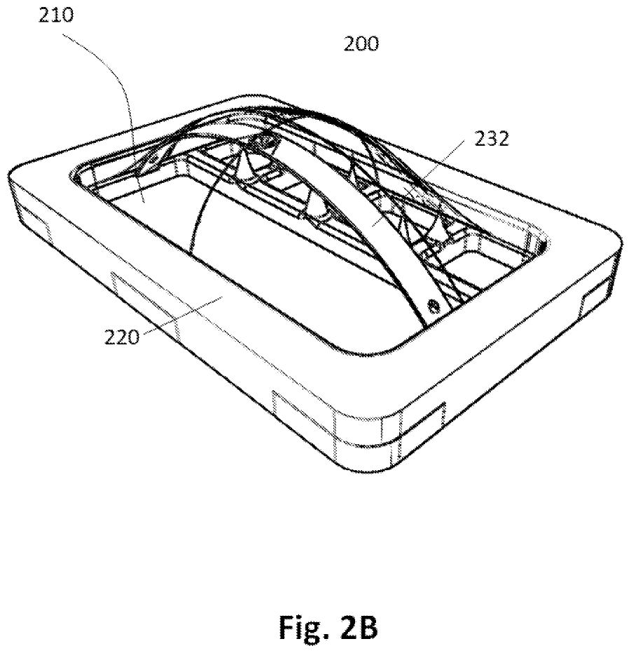

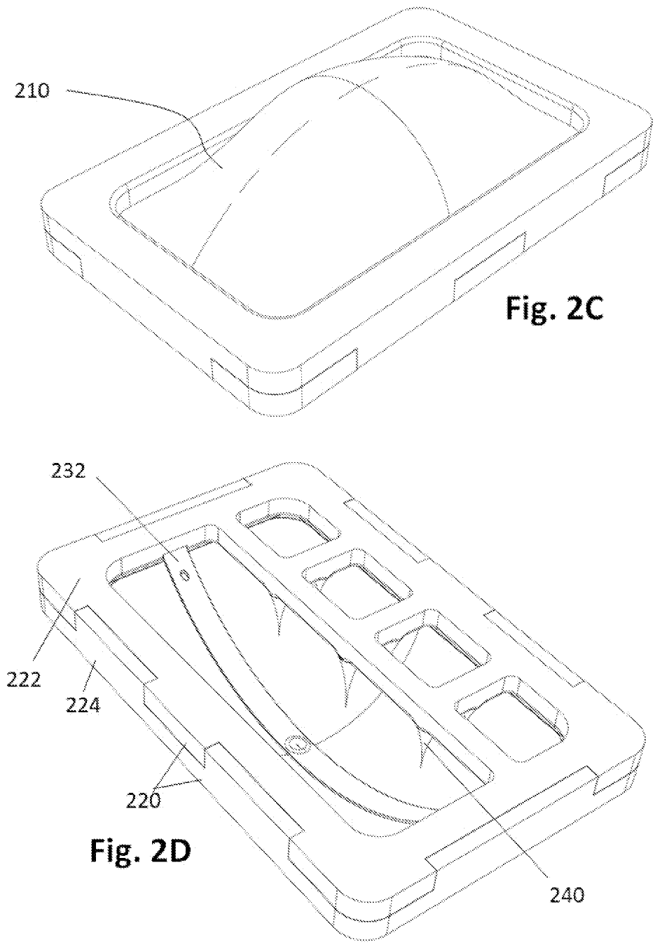

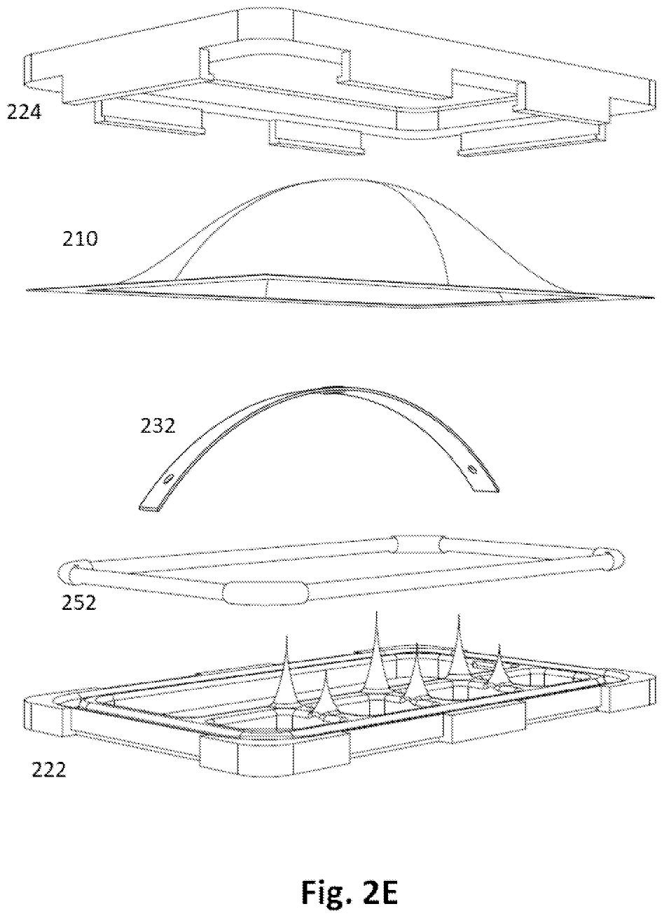

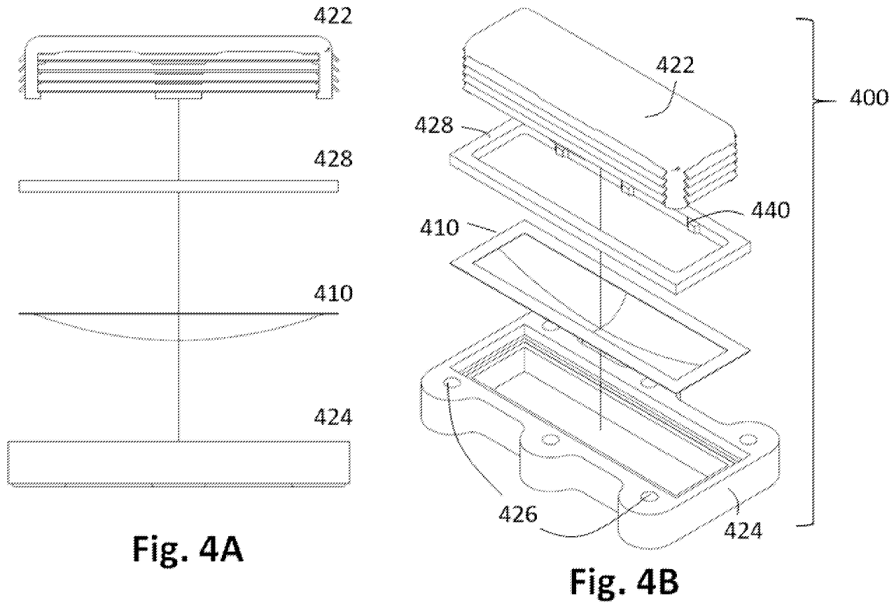

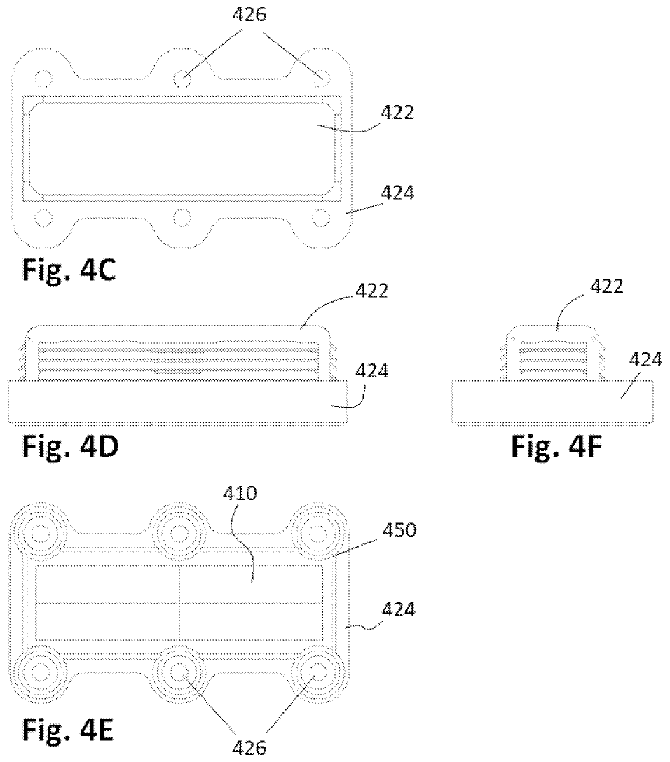

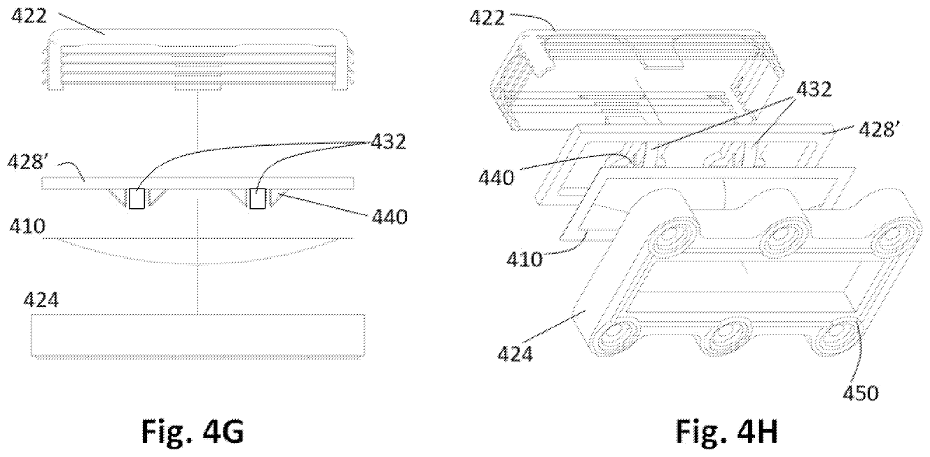

While FIGS. 1A-1C, 8, and 9 illustrate a single piercing mechanism or stress-applying device, it is contemplated that a plurality of piercing mechanisms or stress-applying devices may be used to pierce the pressure retaining membrane and providing at least one tearing edge on which the seal material will propagate its opening. Such a feature provides advantages over conventional devices, in which a puncture hole (i.e., not a tear) is created within a pressure-retaining membrane. Multiple stress-applying devices are depicted, for example, in FIGS. 2A and 4G. Each individual device need not be identical to the others.

According to one embodiment, a piercing mechanism may be provided along with a pressure retaining membrane and housing in an integral pressure relief device assembly (e.g., an integrated knife blade in a device with a sanitary gasket). An integral configuration may be particularly suited for general industry applications where it may be desired to have a pressure retaining membrane or rupture disk without a safety head. For example, an integral configuration may be desirable for a sanitary piping fitting (such as ASME-BPE, DIN, or ISO tri-clamp fittings) where the integrated rupture disk assembly can fit directly into standard pipe fittings, e.g., via a sanitary gasket. As another example, an integrated assembly may be installed directly between industrial pipe flanges without a safety head.

Through the use of a piercing mechanism (or other stress-inducing mechanism), the present disclosure can achieve instantaneous opening characteristics by cutting a relatively large opening in the pressure retaining membrane. As such, the present disclosure represents an advance over conventional lithium battery pack (breathable or non-breathable) pressure relief vents, which open more slowly as the emissions from the battery become hotter and allow the membrane to deform by heat related shrinkage or melting.

Returning to FIG. 1A, the pressure relief device 100 is circular and the pressure-retaining membrane 110 forms a circular dome having a fixed diameter. Other geometries for membranes and pressure relief devices are contemplated. For example, as illustrated in FIGS. 2A-2E, a pressure relief device 200 is provided with a rectangular membrane 210 in a rectangular housing 220, which is comprised of an inlet body 224 and an outlet body 222 with a sealing gasket 252 (visible in FIG. 2E) therebetween. In the embodiment of FIGS. 2A-2E, a support strip 232 provides support for the membrane 210, and a piercing mechanism 240 is provided to pierce the membrane 210 upon reversal. As further examples, the present disclosure contemplates pressure relief devices having oval, square, polygonal (e.g., triangular, pentagonal, hexagonal, octagonal), symmetrical, or asymmetrical shapes. It is also contemplated that irregular or asymmetrical shapes may allow for installation of a pressure relief device on surfaces that ordinarily have not been vented (e.g., curved or profile surfaces). Although FIG. 1A depicts a domed pressure-retaining membrane, in another embodiment a pressure-retaining membrane may be flat or substantially flat. A flat pressure-retaining membrane may be used with other features described herein, including, e.g., a support strip (e.g., 132) and/or a piercing mechanism or stress-applying device (e.g., 140).

The shape of a pressure relief device (or multiple devices) may be selected to fully utilize the available area for pressure relief. Fully utilizing the available area for pressure relief may reduce cost by allowing for more efficient selection of the number of devices required to meet a particular venting need. For example, the rectangular configuration of FIGS. 2A-2E may be suitable in situations where a thin rectangular enclosure is to be vented with one or multiple pressure rectangular relief devices arranged together to provide maximum relief area. As another example, the shape of a pressure relief device may be optimized to allow for the use of a single device (instead of multiple, non-optimized devices). As yet another example, a pressure relief device may be specifically tailored to fit irregularly shaped areas, which typically have been deemed unsuitable for use as a vent location.

As illustrated in FIGS. 1A and 1B, the piercing mechanism 140 has a single piercing element (i.e., a razor edge). In other embodiments, such as illustrated in FIGS. 2A, 2B, 2D, and 2E, the piercing mechanism 240 may have multiple piercing points. Providing multiple piercing points may provide several advantages. For example, multiple piercing points may establish multiple openings or may combine to create a single, larger opening when a pressure-retaining membrane activates. In addition, multiple piercing points may ensure that the membrane will activate even should it reverse non-uniformly. For example, the membrane 210 will be pierced when it comes into contact with any one of the three illustrated piercing points. In this manner, the pressure relief device 200 will activate even if part of the membrane initially does not reverse.

Returning to FIG. 1A, the housing 120 is illustrated with vent holes 126 in the outlet portion of housing body 122, which may allow fluids to escape when the pressure relief device activates. The housing 120 may be made of any material suitable for the intended use (e.g., use with a battery pack). For example, the housing may be polymer, metallic or any other such material as required. In one embodiment, a polymer housing may be used to minimize weight and/or to allow the use of mass production techniques such as injection molding. The outlet housing may be configured with louvers to counteract ingress of environmental debris and even prevent pressurized spray wash access to the membrane 110.

A pressure-retaining membrane 110 may be formed from one or more materials, such as polymers, metals, composites, or any combination thereof. Polymer membranes may be particularly desirable for use in low-pressure applications common to batteries. It is contemplated that the membrane may alternatively be made of other materials as required. For example, Inconel® may be used to improve temperature stability of a membrane. As another example, nickel-based alloys may provide a membrane with improved resistance to environmental hazards as would stainless steel.

In one embodiment, a pressure-retaining membrane may be made of an impermeable material. Alternatively, the membrane may be breathable, i.e., permeable to certain gases. For example, a pressure-retaining membrane may be made from a sintered polytetrafluoroethylene (PTFE) or other materials to provide breathability, while preventing other fluids (e.g., water) to pass through. In an automotive application, water ingress into a battery pack is not permitted, and the battery pack typically must be able to survive under water at a depth of 1 meter (3 feet) for at least half an hour without water ingress. The disclosed device with a breathable, gas-permeable membrane has been demonstrated to meet such requirements, which can also be described as achieving IP67 or even IP68 ingress protection such as is described in Standards IEC 60529 (International Electrotechnical Commission) and its European equivalent EN 60529.

Using a gas-permeable membrane may prevent unwanted activation of the device at extreme normal operating temperatures or pressures. Specifically, gas permeability allows pressure to stabilize across the rupture disk membrane with air flow in either direction. As such, the disclosed membrane may allow a battery pack to desirably maintain a normal operating pressure near ambient atmospheric pressure conditions (such as +/−10 mBar or +/−20 mBar), even when the battery pack is subject to changes in atmospheric pressure or experiences internal vacuum or overpressure when cooled or heated.

According to one embodiment, a pressure-retaining membrane may be provided with one or more lines of weakness. In response to an over-pressure situation, the pressure-retaining membrane may be configured to initiate opening along the line of weakness. Thus, a line of weakness may be used to design a pattern along which the pressure-retaining membrane will open. Furthermore, a line of weakness (or other features imparted into a pressure-retaining membrane—such as indentations, ribs, reinforcements, etc.) may be used to control or otherwise influence the pressure at which the membrane will reverse, open, or burst.

In one embodiment, a line of weakness may be aligned with a piercing mechanism or pressure-applying device (e.g., 140), such that the piercing mechanism or pressure-applying device comes into contact with (or near) the line of weakness upon activation. Alternatively, a line of weakness may not be aligned with any piercing mechanism or pressure-applying device. A line of weakness may be formed by any suitable method, including stamping, scoring, etching, indenting, ablation, laser-ablation, or other process designed to weaken a portion of a pressure-retaining membrane.

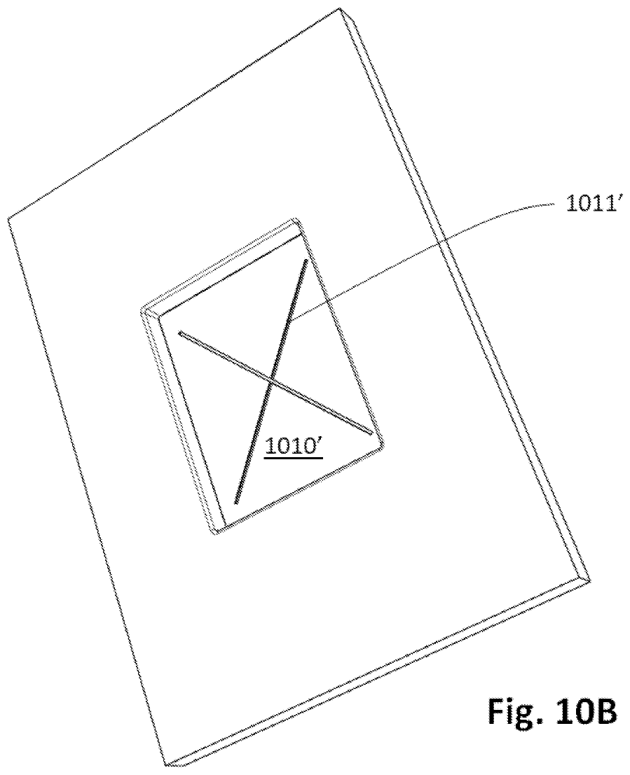

Exemplary lines of weakness 1011, 1011′ are illustrated in FIGS. 10A and 10B. As illustrated, the lines of weakness 1011, 1011′ are comprised of two crossing score lines forming an X-shape at the center of a substantially flat membrane 1010, 1010′.

According to one embodiment, an X-shaped scored line of weakness may be especially beneficial for use with a flat, flexible graphite (e.g., a carbon-resin composite) membrane. Graphite materials may be particularly useful to provide leak-tightness and flexibility for pressure-retaining membranes, especially in high-temperature applications. According to the disclosure, scoring a flexible carbon-resin-type membrane may achieve enhanced performance. Score lines (e.g., the X-shaped score lines illustrated in FIGS. 10A and 10B) may achieve a beneficial opening area while minimizing space required on the downstream side of the membrane to accommodate the “petals” of the opened membrane. In addition, the material properties of the flexible carbon-resin graphite may be able to prevent fragmentation (i.e., prevent “petals” from becoming detached from the rest of the membrane). As such, the disclosed scored membrane provides advantages over typical brittle graphite rupture disks, which tend to crack and fragment into many pieces upon activation and, as such, may be unsuitable for applications such as battery packs, automotive applications, or applications where fragmentation may create a risk of injury or damage to people or equipment.

Although FIGS. 10A and 10B illustrate substantially flat membranes, it is contemplated that a flexible graphite membrane may be provided in a formed-domed shape, and may further be combined with other features disclosed herein (such as, e.g., a support strip and/or piercing mechanism/stress-applying device). The addition of a formed domed structure (which may be symmetrical or asymmetrical) may provide improved resistance to vibration or wind. The addition of a support strip or other support member may enhance the ability of a flexible graphite membrane to resist vacuum or back pressure. In addition, providing a support strip or other support member may permit the use of a flexible graphite membrane with or without one or more score lines. Further, a flexible graphite membrane (which may or may not be scored) may be used as a seal for a tension-loaded pressure relief device, wherein the burst pressure is controlled by a flat or domed perforated metal or plastic member (e.g., a support strip) configured to fail under a predetermined tensile stress.

Although FIGS. 10A and 10B depict multiple lines of weakness forming an X-shape, the disclosure further contemplates a single line of weakness, which may be a straight or curved, or multiple lines of weakness that do not intersect. Moreover, lines of weakness may be provided that form intersecting or non-intersecting patterns different from X-shaped patterns, including T-shaped patterns, Y-shaped patterns, 5-pointed (or more) star-shaped patterns, irregular intersecting patterns, patterns combining multiple curved lines, and patterns combining straight and curved lines. Further, although lines of weakness 1011, 1011′ are depicted as intersecting with the center of the membrane 1010, 1010′, in an alternative embodiment one or more lines of weakness may be offset from the center of a pressure-retaining membrane and may be, for example, positioned near an outer periphery of the membrane.

As illustrated in FIG. 1A and FIGS. 2A-2E, a single pressure-retaining membrane is used. It is also contemplated that multiple membranes can be combined to give improved performance. For example, in one embodiment, a first stainless-steel or other metal membrane may be used in conjunction with a second PTFE membrane wherein the metal membrane provides pressure relief and the PTFE membrane provides normal pressure stabilization by permitting air flow. Further, the first and second membranes may be combined to provide pressure relief and gas permeability with the first membrane having at least one hole. A third PTFE membrane may be provided, with the metal membrane effectively sandwiched between the two PTFE membranes. Such combinations may provide a high degree of corrosion resistance, while retaining the desirable mechanical properties of stainless steel to control burst pressure.

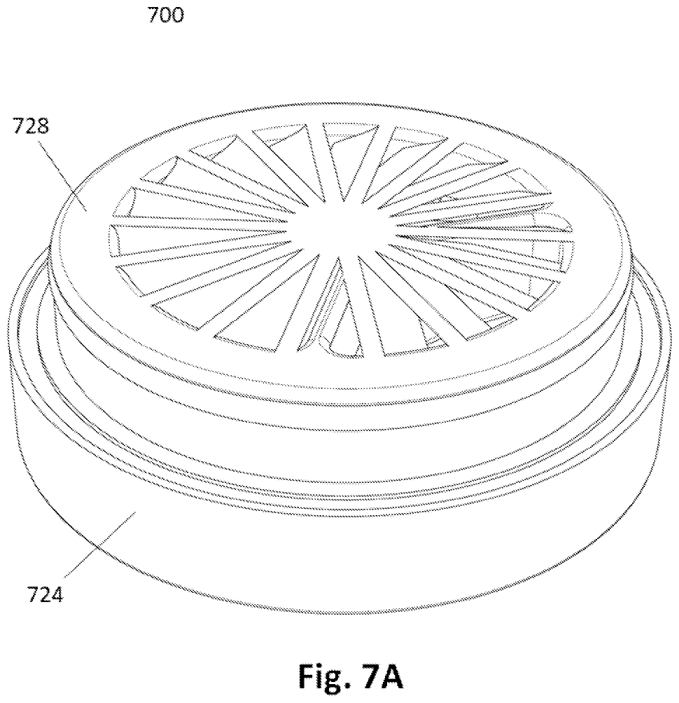

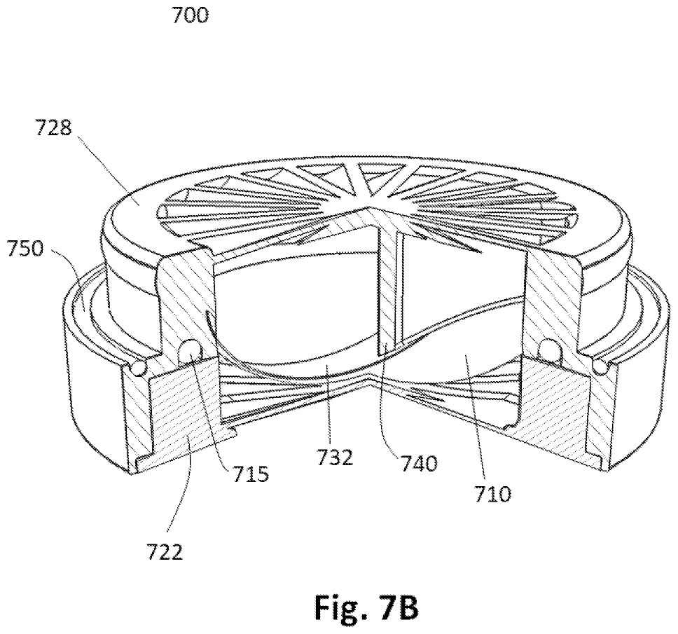

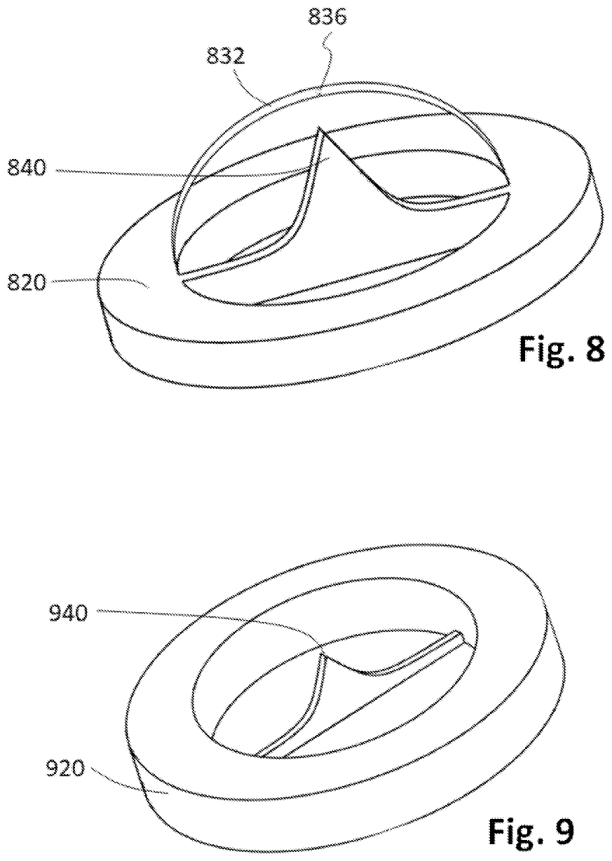

Returning to FIG. 1A, the support member 130 comprises an arched support strip 132 joined at either end to a support member flange 134. Such a support member may be manufactured by removing material from a preformed dome to leave only the flange and support strip. According to this embodiment, the flange 134 of the support module may be held in place against one or more flanges of a housing. Alternatively, the flange 134 of the support module may be held in place against a mated flange on an enclosure (such as a battery). Additional detail of a support member 730 having a support strip 732 and flange 734 is illustrated in FIG. 7.

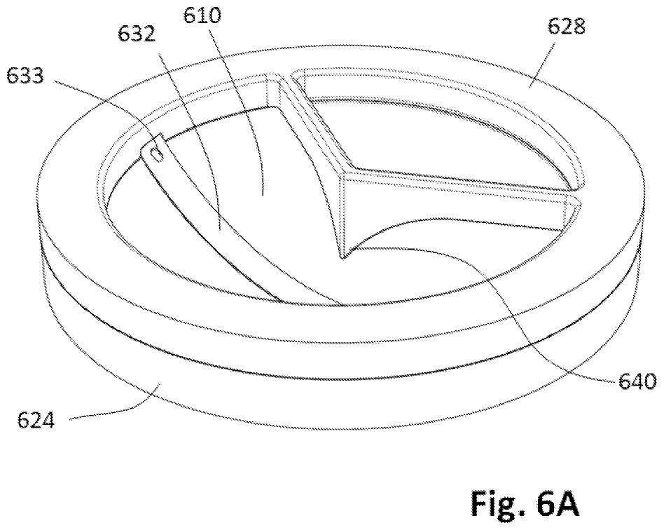

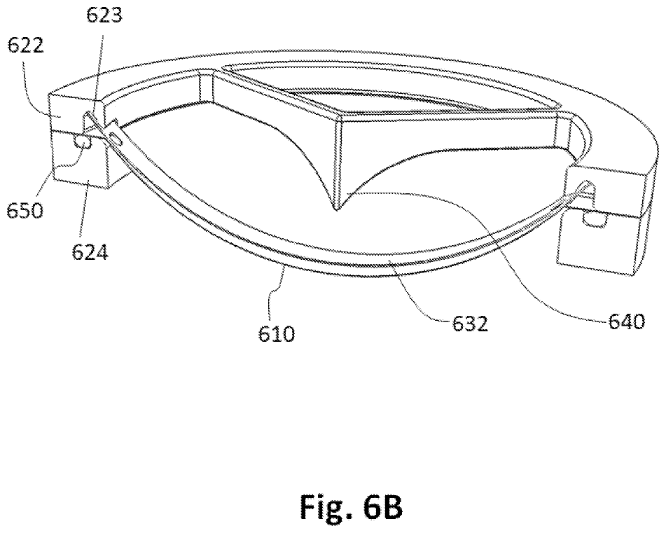

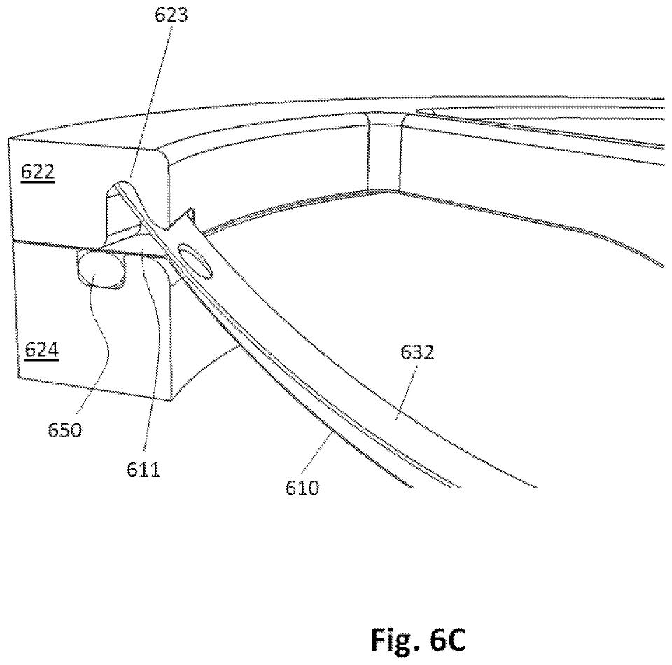

In an alternative design, a support strip may be an individual modular component, which is inserted into an area of the housing designed to accommodate it. Examples of a modular support strip 632, 832, 1032 are illustrated in FIGS. 6, 8 and 10. A modular design allows different support strips to be used as desired for the intended application. For example, a manufacturer or operator may adjust the activation pressure of the pressure relief device by using different support strips. Additionally or alternatively, a manufacturer or operator may select a support strip to optimize performance in the intended environment. For example, a pressure-retaining membrane may require an exotic material due to corrosion concerns, but the support strip can be made from a conventional material. Or a support strip may require an exotic material (e.g., for structural reasons) while a cheaper, conventional material may be used for the pressure-retaining membrane. In this way, performance may be optimized while minimizing cost.

In addition, it may be desirable to replace a support strip and seal membrane after activation, without the need to replace the entire housing, thereby reducing replacement time and cost.

A support strip may be made from a metal; however, other materials (e.g., polymers and ceramics) also are contemplated, and may be selected to optimize performance. As illustrated in FIG. 6, the support strip is formed from a single strip, which may be formed into a curved arch before or during installation into a pressure relief device. The support strip of FIG. 6 has a constant rectangular cross-sectional area; however, in another embodiment, the cross-sectional area of a support strip may vary along the strip.

The geometric properties of a support strip may be tailored to achieve a desired performance. In one embodiment, a support strip may have two or more mounting points for mounting on a housing. In another embodiment, a support strip may be provided with other structural features to facilitate connection of the strip to a housing, pressure-retaining membrane, or other component of a pressure relief device. Various mechanisms to induce weakness or strength in particular portions of the support strip (and thereby control the activation pressure or intended activation point) may be implemented, such as indentations, dimples, holes, notches, bends, curves, ribs, lines of weakness, changes in width along the length and other features. In one embodiment, an indent may be applied to the support strip at its apex, such as indent 836 illustrated in FIG. 8. An apex indent may be used, for example, to tune the activation pressure at which the support strip will collapse.

By changing the design of the support strip, a manufacturer may configure a pressure relief device to cater to a wider range of process applications without needing to make changes to other components such as the support housing or pressure retaining membrane. In this manner, the disclosure facilitates mass production of the base components with major variation only coming from the support strip.

Modification of the support strip profile and number of strips also allows for tailoring of the performance of a device to a certain process scenario. For example, a strategic weakening or strengthening of the support strip(s) to control of the reversal of the strip(s) may enhance the performance of an existing specification. In this manner, a smaller sized device may provide the same or better performance than that of a typical, larger equivalent.

As illustrated in FIGS. 1A-2E, a single support strip may be used. In another embodiment, a plurality of support strips (which may be of different designs) may be combined with or without contact to achieve a desired performance or function. Such a combination may be comprised of identical or non-identical members. In one embodiment, support strips of different profiles can be combined to tailor performance.

In one embodiment, a support strip—especially a metal support strip—may improve the temperature independence of a pressure relief device. For example, existing venting solutions typically rely on a plastic tension-loaded membrane. The tensile strength of such a membrane will vary widely depending on temperature, which results in a wide range of activation pressures in operation. In contrast, the disclosed support strip (e.g., as illustrated in FIG. 1A) may set the activation pressure for the pressure relief device. Under typical use conditions, the mechanical force required to collapse a metal support strip provides a level of temperature independence that ordinary plastic devices have failed to achieve. To illustrate, components in vehicular application may experience normal ranges in service temperature from −40° C. to +85° C. In response to such temperatures, the activation pressure of a typical plastic pressure retaining membrane may vary widely from 150% to 50% of the nominal activation pressure at ambient conditions. In contrast, a stainless steel support strip according to the present disclosure has been observed to reduce this range to between 130% and 70% of nominal activation pressure or better. A Nickel Alloy 600 series support strip has been observed to reduce this range of activation pressure to between 120% and 80% or better. This tighter control of burst pressure is desirable to protect thin walled pressure enclosures such as lithium battery packs.

In addition, a modular support strip may be changed depending on expected environmental conditions to provide a consistent burst pressure regardless of the ambient temperatures.

In one embodiment, a support strip may be produced by a continuous stamping process (e.g., stamping from a coil of material) using a press or other such method that would allow for mass production. In another embodiment, other manufacturing processes such as laser cutting, chemical etching or any other such cutting mechanism may be combined with a separate forming process to produce the required part.

Although FIGS. 1A-2E depict a modular support strip, it is contemplated that a support strip or other support structure may be formed, molded (e.g., injection-molded), or fabricated integrally with another component of a pressure relief device. For example, a support strip may be formed or molded as part of a housing body. Alternatively, a support strip may be formed by removing segments from a flanged dome structure such that only the strip remains attached to the flange. Such a configuration may be particularly suited for sanitary applications (e.g., with an integrated knife blade and sanitary gasket). As another example, a support strip and piercing mechanism both may be provided integrally with a support housing body. Integral formation may provide advantages in mass-manufacture of a pressure relief device. As with a modular support strip, an integral support strip may include holes, indentations, pinch points, notches, lines of weakness, strengthening/reinforcing structure (e.g., ribs or embossments), or other features to control how, where, and under which conditions the support strip will deform and/or fail.

Returning to the housing of a pressure relief device, the housing may be mounted on an enclosure, such as a battery, in several alternative ways. For example, the housing may be mounted on an enclosure via mechanical fasteners (e.g., rivets, screws, multipart cam-lock setups, interference fit setups, bolts), welding (metallic or non-metallic), or adhesive bonding. In one embodiment, the housing (and other components of the pressure relief device) may be configured for use in sanitary applications, such as pharmaceutical or food production, which require a high degree of chemical compatibility and corrosion resistance.

The housing may be configured such that the mounting mechanism may be independent of the support strip and pressure-retaining membrane, as well as any structure that holds the strip and membrane. In this way, different ways of mounting can be introduced without altering the core structure and function of the pressure relief device. Likewise, the same base device design may be used across a number of different applications and satisfy a wide range of customer requirements for mounting mechanisms.

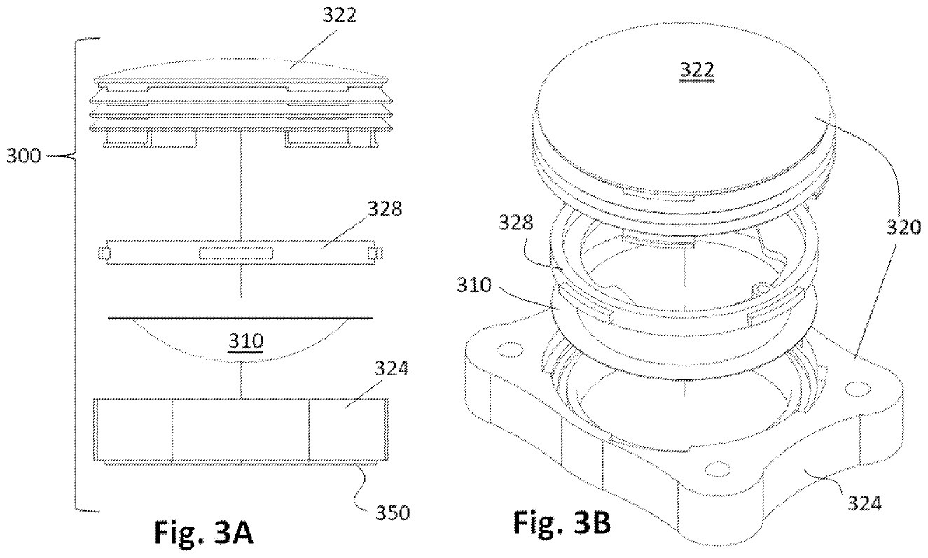

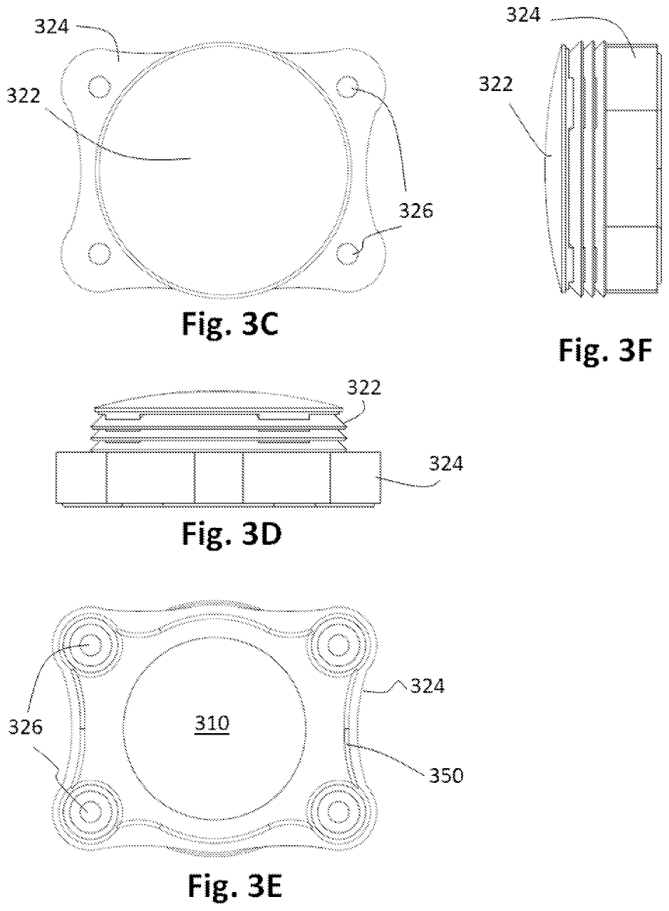

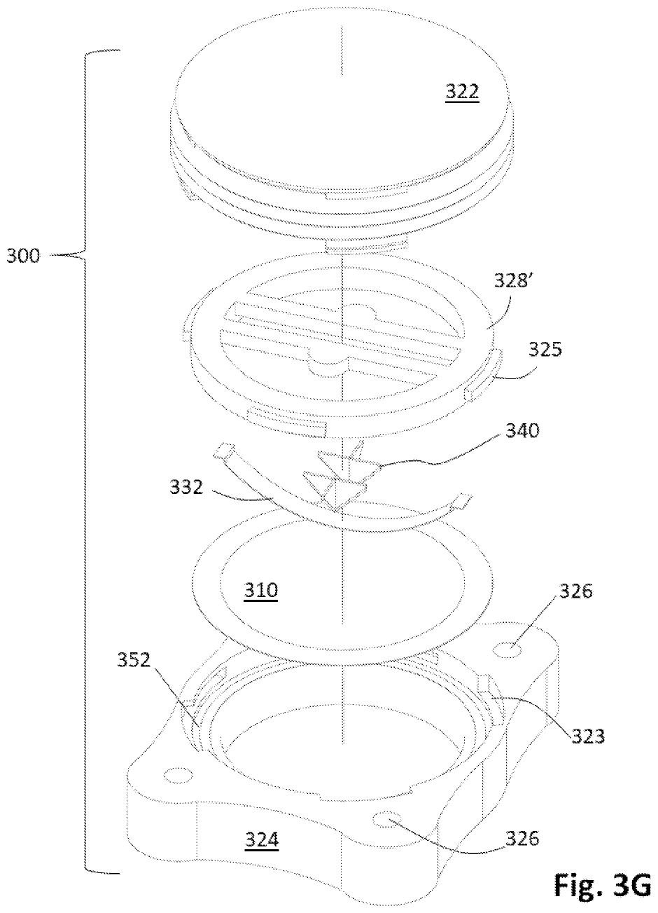

One example of a housing for a pressure relief device 300 is illustrated in FIGS. 3A-3G. As illustrated, the housing 320 has an outlet portion 322 and an inlet portion 324. A pressure-retaining membrane 310, such as a rupture disk, is held between the inlet 324 and outlet 322 portions of the housing 320. As illustrated in FIG. 3C and FIG. 3E, the housing 320 is provided with bore holes 326, which may accommodate bolts or other mechanisms for attaching the housing to an enclosure or process. In an alternative embodiment, a pressure relief device may be attached to an enclosure or process by other mounting mechanisms, such as mated threads, clamps, snap fittings, tabs, adhesive bonding, or welding.

As best illustrated in FIGS. 3A and 3E, a seal 350, in the form of a gasket, may be provided to create a seal between the housing and an enclosure or process (such as a battery) to which the housing is mounted. Other sealing mechanisms are contemplated, such as an O-ring, bite seal, or concentric/spiral serrations such as may be used on a flange. In one embodiment, the membrane itself may form a sealing mechanism. For example, the membrane may include a flange portion that may be used to form a seal between the pressure relief device housing and the enclosure to which it is mounted. As with the membrane and housing, the shape of the seal can be round, polygonal, regular, irregular, symmetric, or asymmetric.

In one embodiment, the housing can be changed to accommodate different sealing mechanisms without compromising the core functionality of the pressure relief device. For example, a groove can be added to house an O-ring or a surface to support a gasket. In another embodiment, elements of the housing itself may become part of a sealing mechanism. For example, the housing may be provided with concentric/spiral serrations or raised ridges that can mate to an appropriate sealing surface on enclosure (e.g., battery pack) and are engaged with a suitable fastening method.

As with mounting mechanisms, customers may have different preferred means of sealing of a pressure relief device to an enclosure. Offering a variable sealing mechanism allows for the product to be compatible with multiple different customer setups. Moreover, in cases such as O-rings and gaskets, different materials can be selected to provide optimum performance for the intended process conditions. Further, a replaceable seal also aids maintainability, facilitating reuse of the product and eliminating potential waste.

Returning to pressure relief device 300, additional features are illustrated in FIGS. 3A-3G. For example, FIGS. 3A and 3B illustrate an exploded component view of one configuration of the pressure relief device 300. As illustrated in FIGS. 3A and 3B, a support ring 328 may be used to hold the membrane 310 in place against the housing inlet 324. In this configuration, the membrane 310 may be a metal membrane held within a plastic housing 320. Further, the support ring 328 may be made of plastic and include at least one stress-concentrating point configured to engage with a line of weakness (not illustrated) in the membrane. In contrast to conventional systems, which rely on a metal outlet support ring, the plastic-ring configuration illustrated in FIGS. 3A and 3B achieves the advantages of lower cost, lighter weight, and easier manufacture.

Additional details of the configuration of FIGS. 3A and 3B are depicted in FIGS. 3C-3F, which illustrate the assembled configuration from the top (FIG. 3C), front (FIG. 3D), bottom (FIG. 3E), and side (FIG. 3F).

FIG. 3G illustrates an alternative configuration of the pressure relief device 300 shown in FIGS. 3A-3F. Specifically, FIG. 3G depicts an alternative support ring 328′, which includes integral supports for piercing mechanisms (blades 340) and a support strip 332. Also illustrated is a seal 352, which may be provided to create a seal between the housing inlet 324 and the pressure-retaining membrane 310 which may be metal, plastic or a combination of materials.

Another embodiment of a pressure relief device 400 is illustrated in FIGS. 4A-4H. As illustrated, pressure relief device 400 has a rectangular configuration. Pressure relief device 400 may include features similar to those included in pressure relief device 300, arranged in a similar manner. For example, pressure relief device 400 includes a housing 420 comprising a housing inlet 424 and outlet 422, as well as a sealing gasket 450 (FIGS. 4E and 4H) and pressure-retaining membrane 410. Bolt holes 426 also are illustrated.

In one configuration, illustrated in FIGS. 4A and 4B, a support ring 428 is provided, which may be used to hold the membrane 410 in place against the housing inlet 424. In this configuration, the membrane 410 may be a metal membrane held within a plastic housing 420. Further, the support ring 428 may be made of plastic and include at least one stress-concentrating point 440 that may be configured to engage with a line of weakness (not illustrated) in the membrane. In contrast to conventional systems, which rely on a metal outlet support ring, the plastic-ring configuration illustrated in FIGS. 4A and 4B achieves the advantages of lower cost, lighter weight, and easier manufacture. Additional details of the configuration of FIGS. 4A and 4B are depicted in FIGS. 4C-4F, which show the assembled device from the top (FIG. 4C), front (FIG. 4D), bottom (FIG. 4E), and side (FIG. 4F).

In another configuration, illustrated in FIGS. 4G and 4H, an alternative support ring 428′ includes integral supports for piercing mechanisms (blades 440) and support strips 432. Also illustrated is a seal 452, which may be provided to create a seal between the housing inlet 424 and the pressure-retaining membrane 410. In a further embodiment of this configuration, the support ring 428′, piercing mechanisms 440, and/or support strips 432 may be integrated as a single component—e.g., the components may be injection molded as an integral piece.

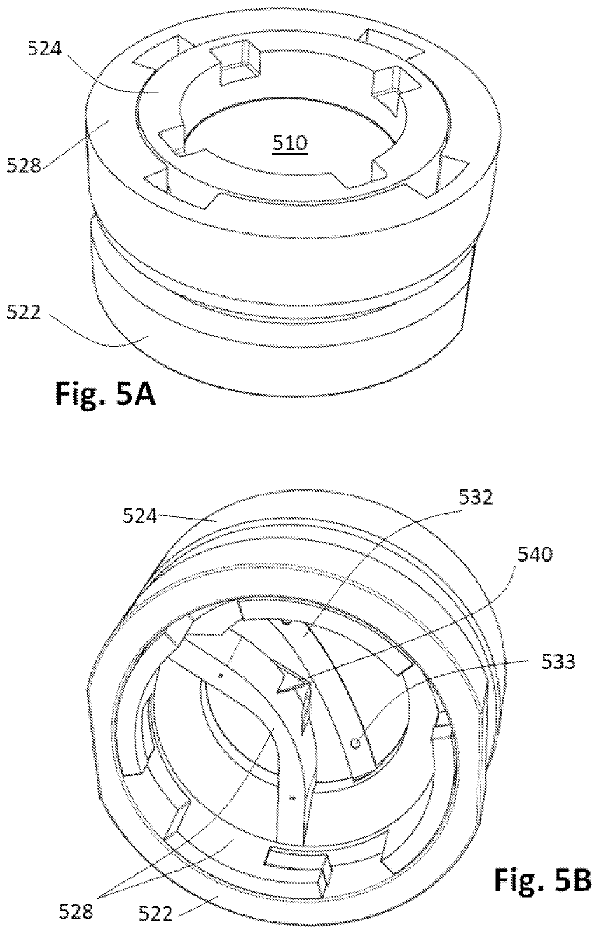

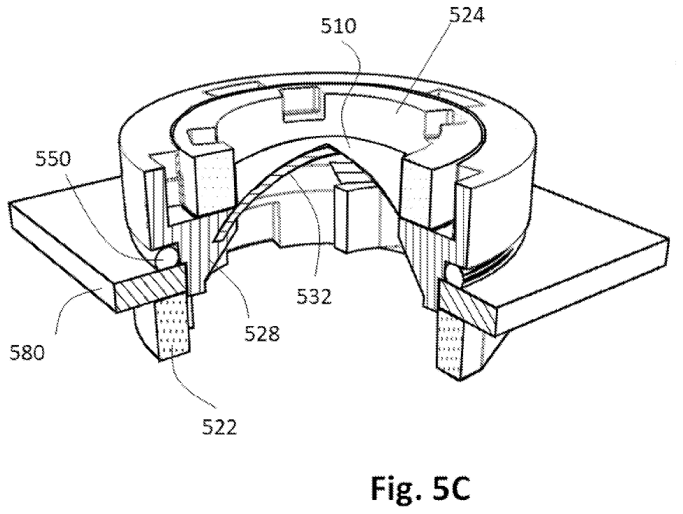

FIGS. 5A-5C illustrate another embodiment. As illustrated, a pressure relief device includes an inlet housing 524 and a support member 528, with a pressure-retaining membrane 510 held therebetween. As shown in FIG. 5B, a piercing mechanism 540 may be mounted on the support member 528. Alternatively, the piercing mechanism 540 may be formed integrally with the support member 528, or may be a separately provided component (e.g., a knife blade). FIG. 5B also depicts a support strip 532 positioned on the downstream side of the membrane 510. The support strip 532 may be provided with features (such as holes 533) configured to induce failure in response to a predetermined system pressure, thereby allowing the membrane 510 to collapse into the piercing mechanism 540 and open.

FIGS. 5A and 5B further illustrate an outlet housing 522, which mates to the support member 528 as illustrated in FIG. 5B. In this manner, the outlet housing 522 and support member 528 may mount the assembled pressure relief device within an opening in an enclosure or process boundary 580, as shown in FIG. 5C. A gasket 550 may be provided to create a leak-tight seal between the device and the boundary 580.

FIGS. 6A-6C illustrate a further embodiment. As illustrated, a pressure relief device includes an inlet housing 624 and a support member 628, with a pressure-retaining membrane 610 held therebetween. As shown in FIG. 6A, the support member 628 includes a piercing mechanism 640. A support strip 632 is mounted on the support member 628 and provides support to the membrane 610. One or more holes 633 or other features may be provided to control the load under which the support strip 632 will fail, allowing the membrane 610 to come into contact with the piercing mechanism 640 and open.

FIG. 6B illustrates a cross-sectional view of the device of FIG. 6A, depicting the inlet housing 624, support member 622, membrane 610, piercing mechanism 640, and support strip 632. As illustrated, a gasket 650 provides a leak-tight seal between the inlet housing 624 and a flange of the membrane 610. Further, the support member 622 includes one or more notches 623 into which the ends of the support strip 632 may be fitted.

FIG. 6C provides additional detail of the interaction between gasket 650 and the flange 611 of the membrane 610, according to the embodiment illustrated in FIG. 6B.

FIGS. 7A-7B illustrate another embodiment. As illustrated, a pressure relief device 700 includes an inlet housing 724 and a support member 728, with a pressure-retaining membrane 710 held therebetween (as best illustrated in FIG. 7B). As shown in FIG. 7B, a gasket 715 may be provided to create a leak-tight seal between the inlet housing 724 and support member 728. Another gasket 750 may be provided to create a leak-tight seal between the device 700 and a process or enclosure (not illustrated) to which it is attached. FIG. 7B further depicts that the support member 728 includes a piercing mechanism 740 and holds a support strip 732, which supports the membrane 710. When pressure on the membrane reaches a predetermined limit, the support strip 732 may deform or fail, allowing the membrane 710 to come into contact with piercing mechanism 740, which causes the membrane 710 to open and release pressurized fluid from the system.

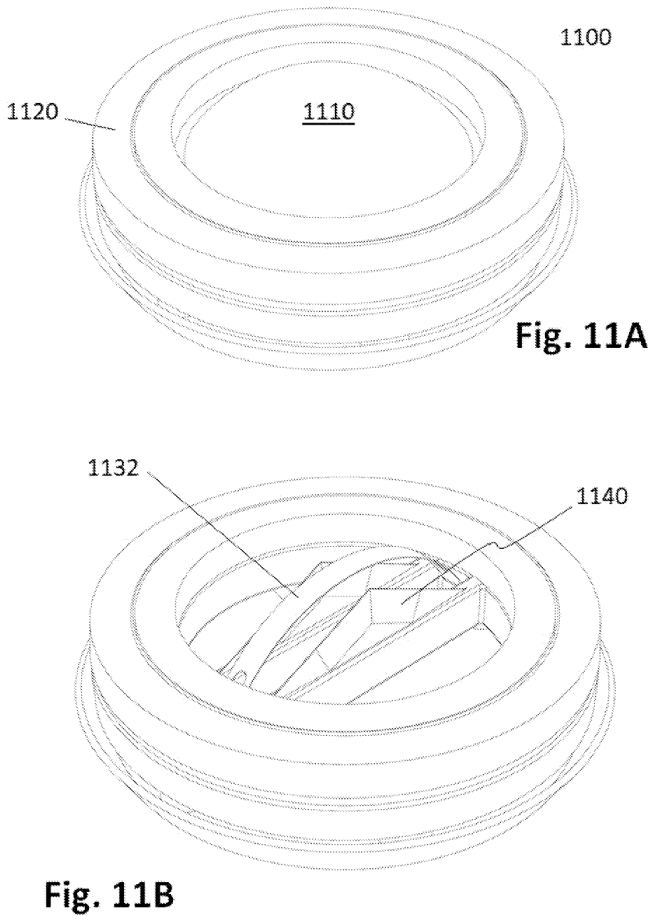

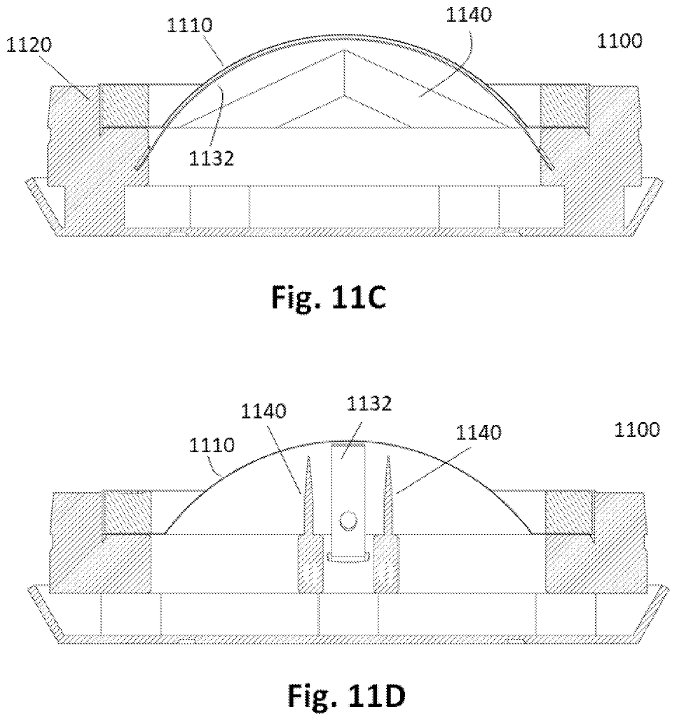

FIGS. 11A-11D illustrate a further embodiment. As illustrated in FIG. 11A, a pressure relief device 1100 includes a pressure-retaining membrane 1110 held within a housing 1120. An arched support strip 1132 is positioned behind the membrane, as best illustrated in FIG. 11B, in which the membrane has been removed. The support strip 1132 holds the membrane away from piercing mechanisms 1140 until, in operation, the support strip 1132 is caused to collapse. Additional details of pressure relief device 1100 are shown in the cross-sectional views provided in FIGS. 11C and 11D. In a further embodiment of this configuration, the piercing mechanism 1140 and/or support strip 1132 may be integrated into the housing 1120 as a single component.

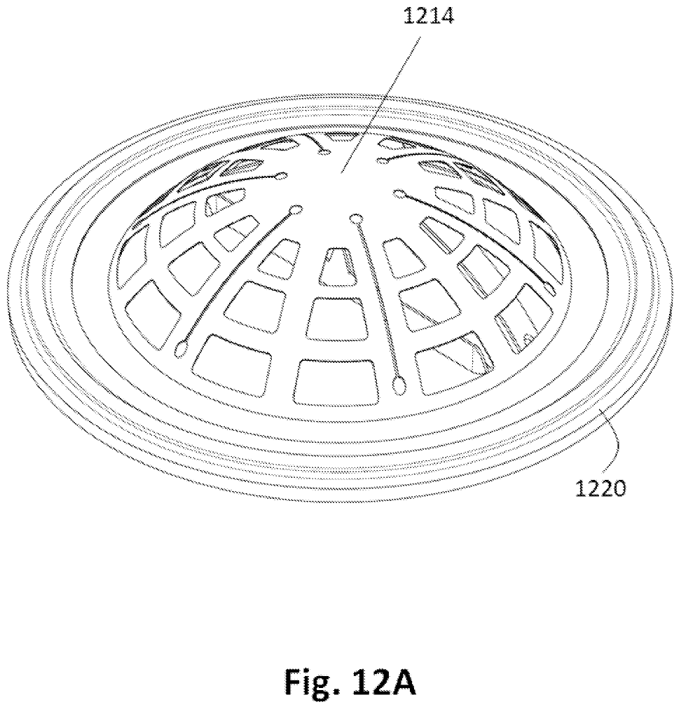

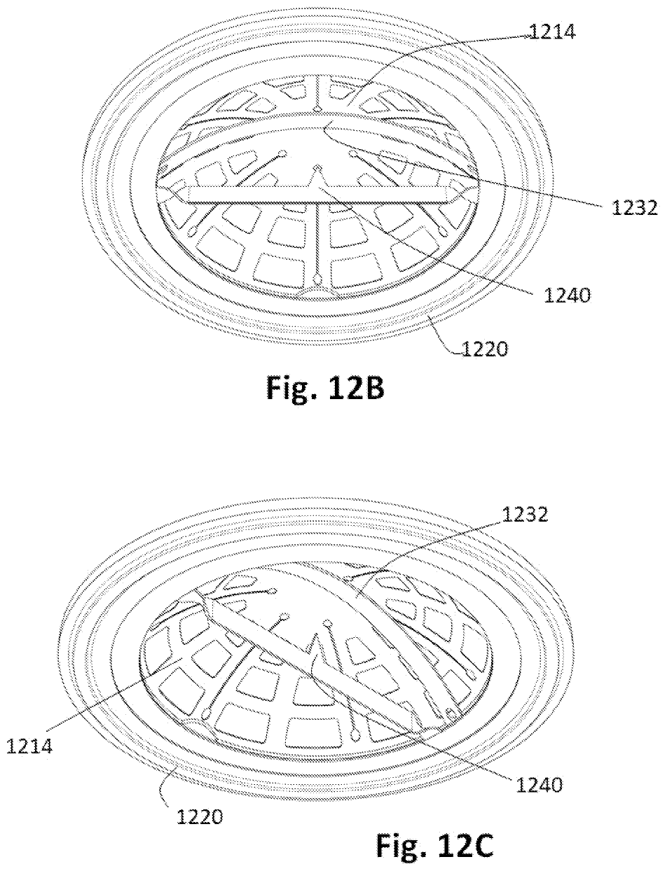

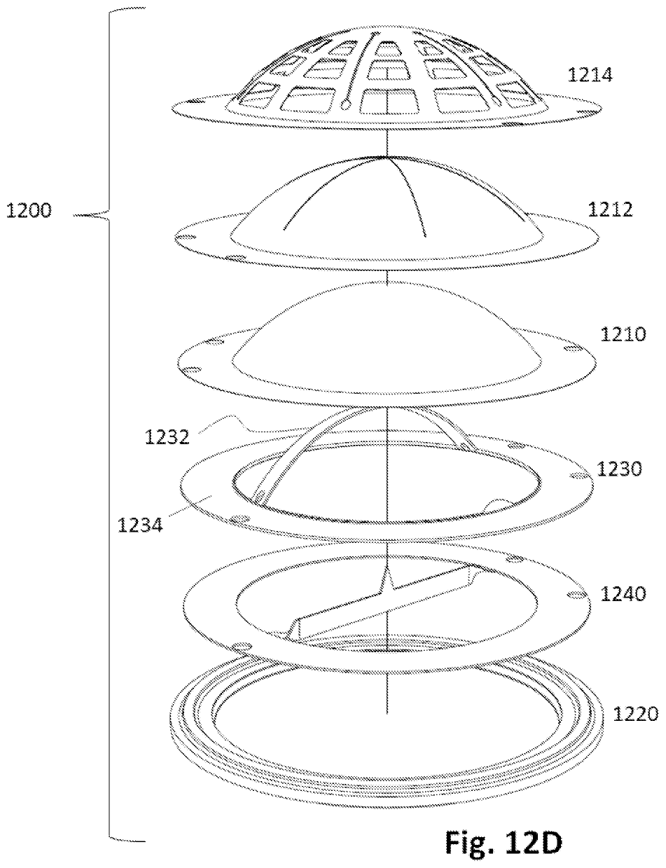

FIGS. 12A-12D illustrate another embodiment of a pressure relief device 1200. As best shown in FIG. 12D, the pressure relief device 1200 includes a support member 1230 having a support strip 1232 and a flange 1234, as well as a piercing mechanism 1240. The pressure relief device 1200 includes a compound pressure-retaining membrane assembly, comprised of three layers 1210, 1212, and 1214. First layer 1210 may be a polymer membrane. Second layer 1212 and third layer 1214 may provide membrane 1210 with additional protection or strength. Layer 1212 may, for example, protect membrane 1210 against abrasion from layer 1214, particularly in applications where abrasion may result in unintentional failure or leakage of membrane 1210. The various components of device 1200 are assembled onto support housing 1220. FIG. 12A depicts the assembled device 1200 from above, while FIGS. 12B and 12C depict the assembled device 1200 from below. The components 1210, 1212, 1214 may be calibrated by the manufacturer to achieve a controlled burst pressure in both directions.

In an alternative embodiment, one or more layers may be omitted from the pressure relief device 1200. For example, the pressure relief device 1200 may be provided without components 1212 and/or 1214. Such a configuration may be desired when there is no need for pressure protection from both directions (i.e., when a one-way pressure relief device is sufficient). Additionally, and/or alternatively, element 1212 may be omitted to save cost, when there is no need for a protective layer 1212 between elements 1210 and 1214.

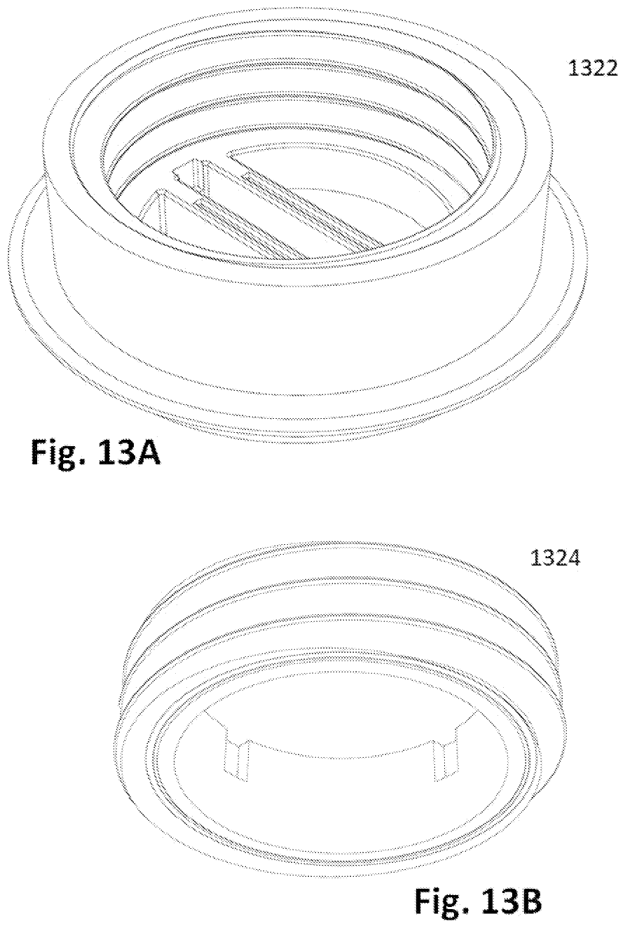

FIGS. 13A and 13B illustrate another embodiment of a housing of a pressure relief device. As illustrated, the housing comprises an inlet member 1324 (FIG. 13B) and an outlet member 1322 (FIG. 13A), which are provided with mated threading patterns. According to this embodiment, the inlet and outlet members 1324, 1322 may be threaded together to form the housing. In this manner, various components of the pressure relief device, such as a support strip, piercing mechanism, and pressure-retaining membrane (not shown in FIGS. 13A and 13B) may be retained within the housing. Thus, every element of the pressure relief device may be provided as a pre-assembled unit for ease of installation.

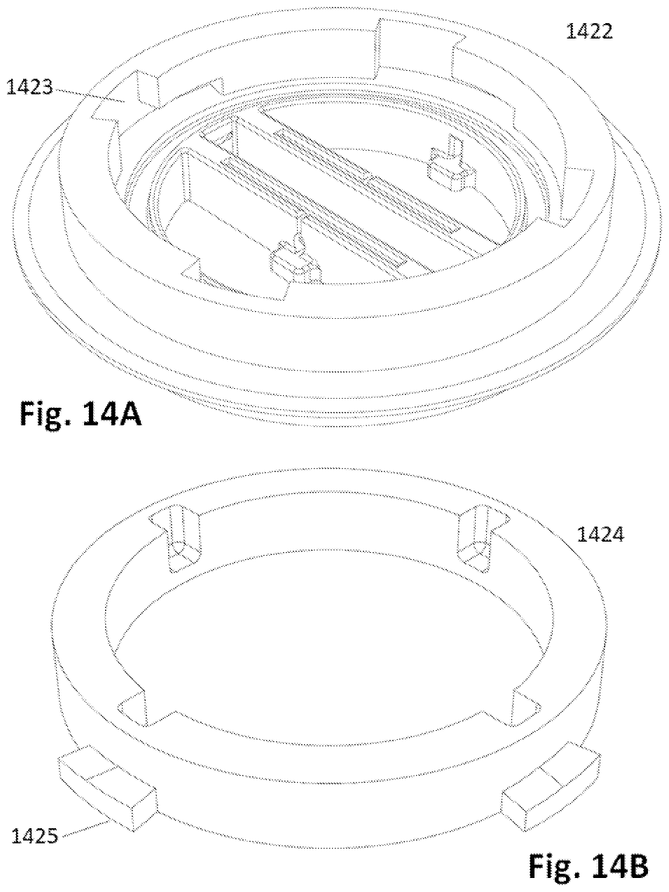

FIGS. 14A and 14B illustrate still another embodiment of a housing of a pressure relief device. As illustrated, the housing comprises an inlet member 1424 (FIG. 14B) and an outlet member 1422 (FIG. 14A). The inlet member 1424 is provided with tabs 1425, which are configured to fit within grooves 1423 formed within the outlet member 1422. According to this embodiment, the inlet and outlet members 1424, 1422 may be fitted and locked together to form the housing. In this manner, various components of the pressure relief device, such as a support strip, piercing mechanism, and pressure-retaining membrane (not shown in FIGS. 14A and 14B) may be retained within the housing. Thus, every element of the pressure relief device may be provided as a pre-assembled unit for ease of installation.

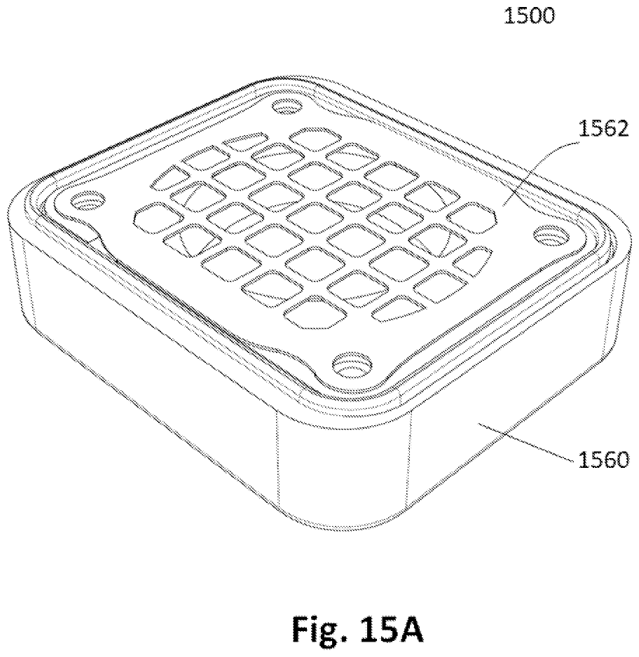

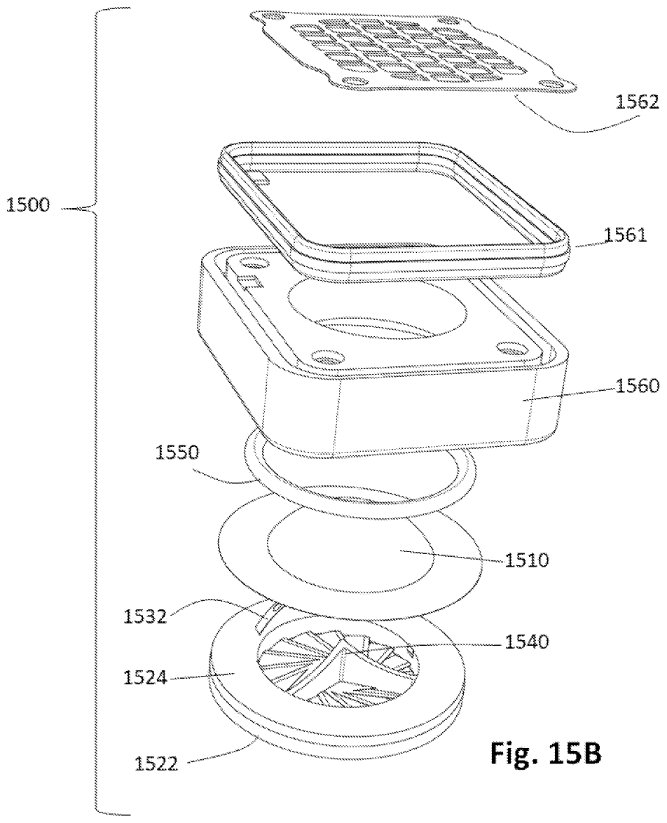

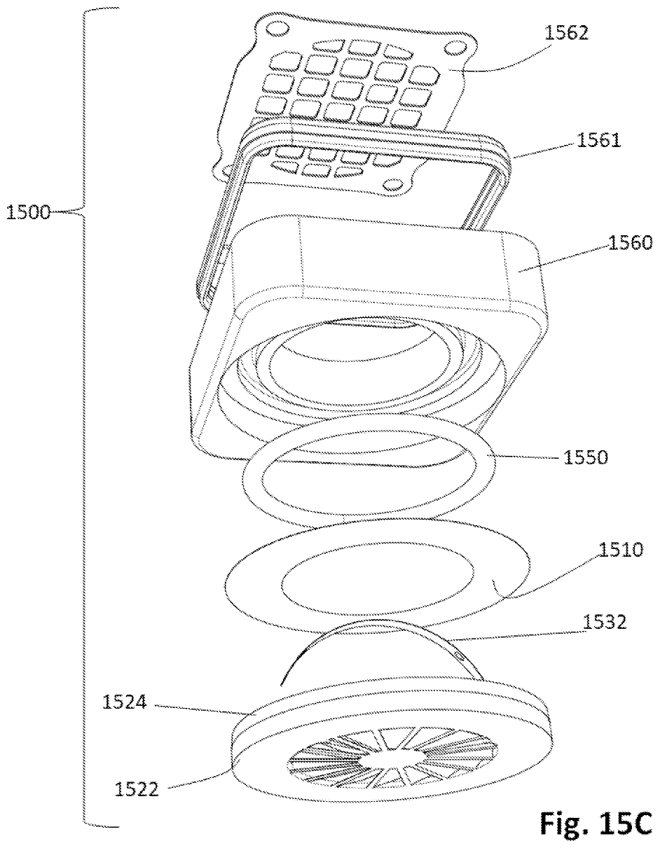

FIGS. 15A-15C illustrate an additional embodiment. As illustrated, a pressure relief device 1500 includes an inlet housing 1560, with an inlet protected by a screen 1562. The screen 1562 may block debris while still allowing fluid to pass through. As best illustrated in the exploded views depicted in FIGS. 15B and 15C, device 1500 includes an outlet housing 1522 and support member 1524. A piercing mechanism 1540 may be formed as part of the housing 1522 or support member 1524, or may be a separate component attached to the housing 1522 or support member 1524. A support strip 1532 may be mounted on the support member 1524, to support a membrane 1510. A first gasket 1550 may be provided to create a seal between the membrane 1510 and inlet housing 1560. A second gasket 1561 may be provided to create a seal between the inlet housing 1560 and an enclosure or process.

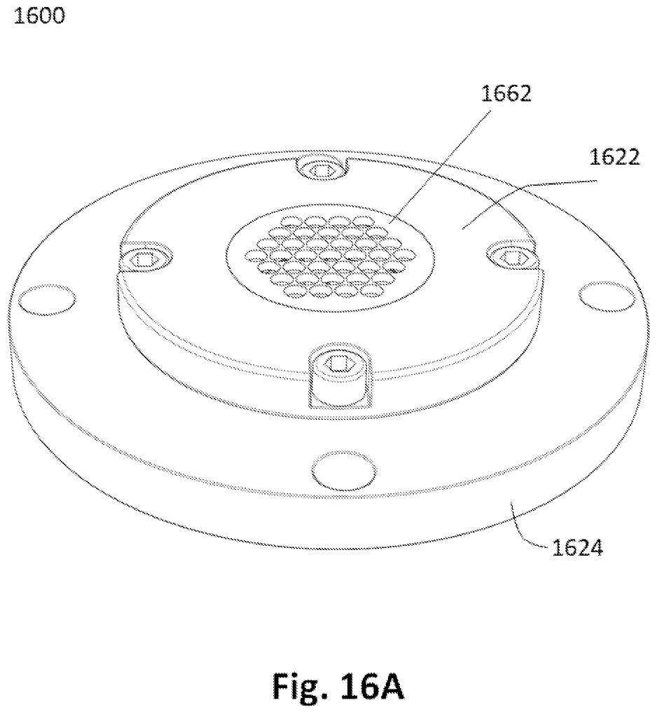

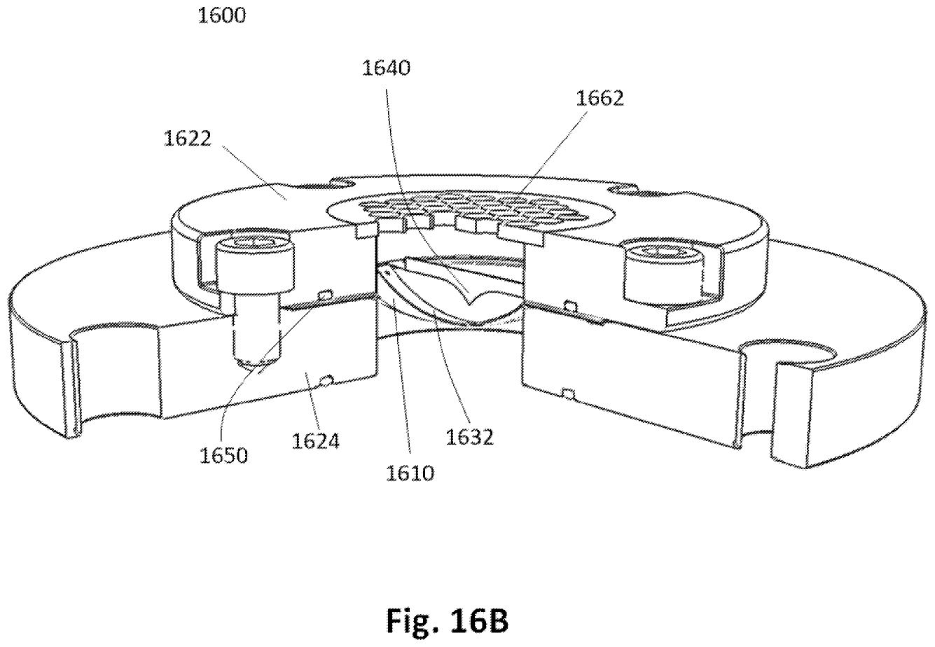

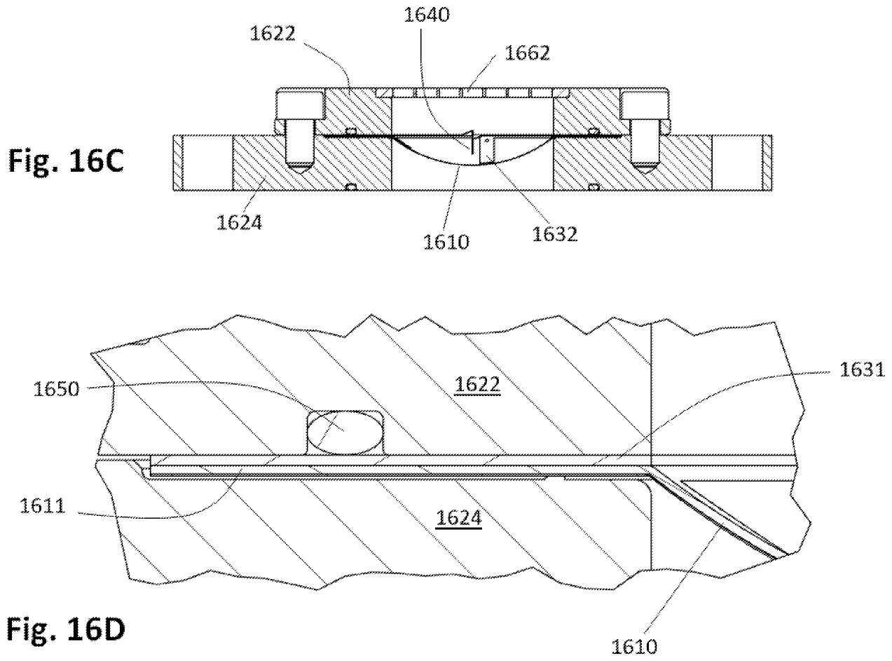

FIGS. 16A-16D illustrate a further embodiment. As illustrated, a pressure relief device 1600 includes an outlet housing 1622, with an outlet protected by a screen 1662. The screen 1662 may block debris while still allowing fluid to pass through. As best illustrated in the cross-sectional views depicted in FIGS. 16B and 16C, device 1600 includes an outlet housing 1622 and support member 1624, which are joined together with a pressure-retaining membrane 1610 between them. A support strip 1632 keeps the pressure-retaining membrane 1610 out of contact with a piercing mechanism 1640 until some predetermined system pressure is reached. As best illustrated in FIG. 16D, a gasket 1650 may be provided to create a seal between the outlet housing 1622 and a flange 1632 from which one or more of the support strip 1632 and piercing mechanism 1640 may extend. FIG. 16D further illustrates a flange 1611 of the membrane 1610, held between the inlet housing 1624 and flange 1632.

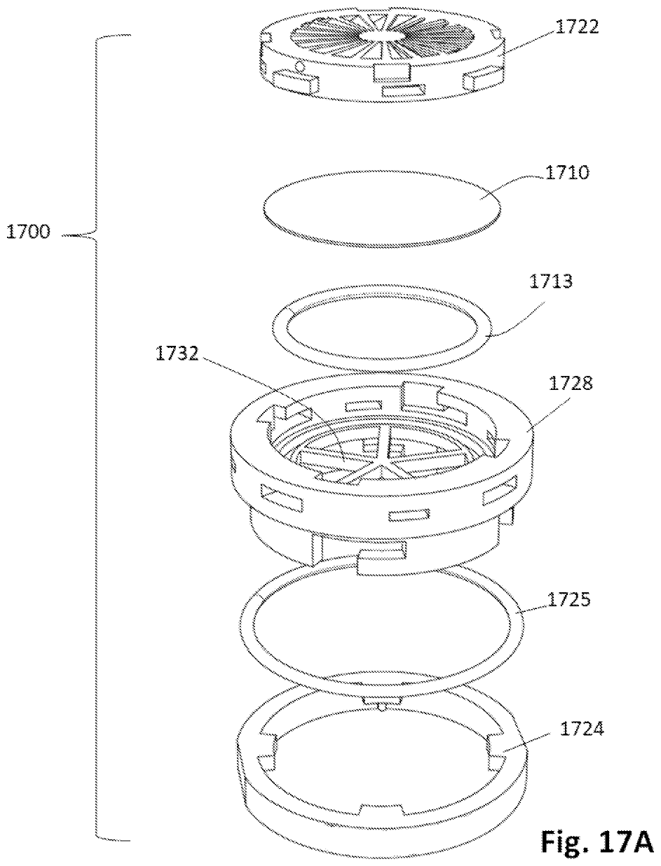

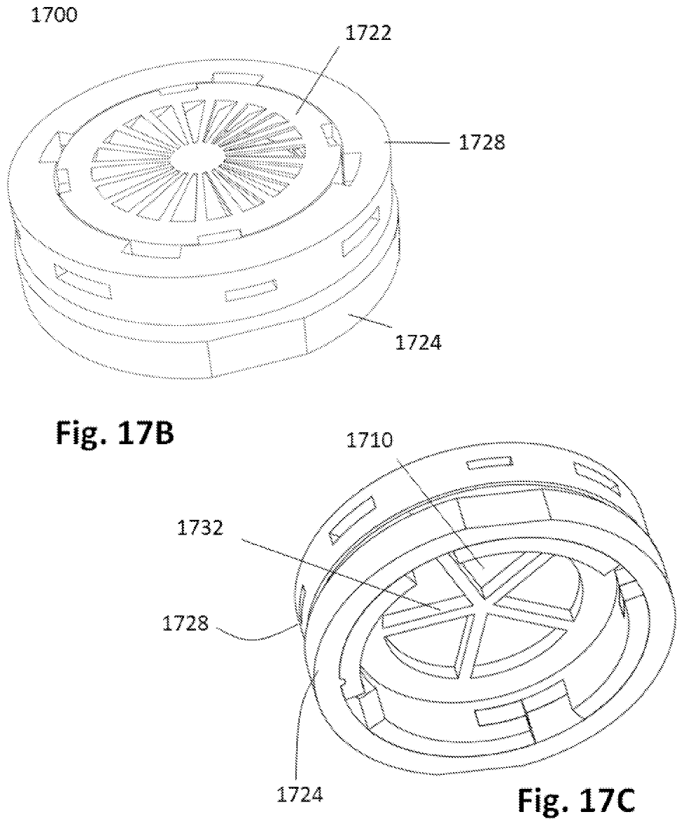

FIGS. 17A-17C illustrate an additional embodiment. As illustrated, a pressure relief device 1700 includes a locking ring 1724 and outlet ring 1722, with an inlet body 1728 therebetween. A membrane 1710, which may be a flexible graphite membrane (e.g., formed from a carbon-resin composite) is held between the locking ring 1724 and inlet body 1728, with a gasket 1713 creating a leak-tight seal between the membrane 1710 and support ring 1728. The support ring 1728, in turn, is sealed to the outlet ring 1722 by use of a second gasket 1725. In another embodiment, a bite seal may be used as an alternative or in addition to a gasket. As illustrated, the outlet ring 1722 may provide structure to diffuse flow and/or protect the membrane 1710 from impact.

The illustrated locking ring 1724, inlet body 1728, and outlet ring 1722 are depicted as having a “bayonet-style” attachment mechanism—i.e., with tabs that fit within mated slots and then rotate into locked position. One or more such components may be held together via different mechanisms, such as threading (e.g., as shown in FIG. 13B), welding/soldering, adhesive bonding, snap-fitting, or other suitable mechanisms. Similarly, a pressure relief device 1700 may be attached to a process boundary by any number of suitable mechanisms, including bayonet-style locking mechanisms, screw threading, snap fitting, adhesives, or other mechanisms.

As depicted in FIGS. 17A-17C, integral support braces 1732 form a star pattern on the inlet side of the membrane 1710; however, other configurations of braces may be used (such as a single brace, crossed braces, or parallel or angled braces). Support braces 1732 may provide structural support for the membrane 1710. When system pressure exceeds safe levels, the membrane 1710 may tear, allowing fluid to escape between the support braces 1732 and out from the system. The membrane 1710 may or may not be provided with one or more lines of weakness to control its opening pattern or the pressure at which the membrane 1710 will open.

Although FIGS. 17A-17C illustrate a flat graphite membrane 1710, in another embodiment a pressure-retaining membrane may be domed. In such an embodiment, the support braces also may be domed and generally follow the shape of the pressure-retaining membrane.

A pressure relief device according to the present disclosure has been observed to provide improved performance over known devices. For example, one embodiment of a pressure relief device may achieve a burst tolerance of +/−10% of set burst pressure, which compares favorably against known devices having a burst tolerance of +/−37.5% of set burst pressure. In addition, principles of the present disclosure may provide improved temperature correction factors. As another example, a disclosed embodiment of a pressure relief device may provide a temperature correction factor of 0.625 at a temperature of 85° C. and 1.08 at a temperature of −40° C. Those temperature correction factors are much better than may be achieved with a typical plastic pressure relief device. Improved temperature stability is particularly pronounced in low-temperature applications, where the burst pressure of a typical device may double (temperature correction factor of ˜2.0) for a tension-loaded, flat plastic membrane device. As yet another example of improved performance, a disclosed embodiment may achieve improved “Minimum Net Flow Area” (MNFA) after activation. MNFA refers to the percentage area of a pressure relief device that may be open to flow after activation, and is a measure of the device's ability to vent fluid efficiently after activation. Embodiments may achieve MNFA values of greater than 50%, greater than 60%, or greater than 70%.

While several of the foregoing illustrated embodiments are directed to a pressure relief device for a battery, the disclosure is not so limited. For example, it is contemplated that the disclosed pressure relief device may be used in any number of applications in which a rupturable pressure relief device, such as a rupture disk, may be used to relieve pressure from an enclosure or process.

The previously discussed embodiments are disclosed as exemplary only and not as limiting the scope of the disclosure to the particular embodiments. Every embodiment disclosed above is not intended to be exclusive or stand alone. For example, it is contemplated that the particular features in any one embodiment can be substituted for, or replaced with, the features of any other embodiment (even though such a particular embodiment may not be explicitly disclosed).

Other embodiments will be apparent to those skilled in the art from consideration of the specification and practice of the disclosure herein. It is intended that the specification and examples be considered as exemplary only.

What is claimed is:

1. A pressure relief device, comprising:
a pressure-retaining membrane;
a support strip positioned adjacent to a surface of the membrane, wherein the support strip is configured to support the membrane when the membrane is subjected to pressure from a pressurizable volume; and
a stress-applying device;
wherein the support strip is configured to activate by deforming in response to a predetermined pressure acting on the membrane; and
wherein the membrane is configured to contact the stress-applying device when the support strip has deformed.

2. The pressure relief device of claim 1, wherein the membrane is formed of a polymer material.

3. The pressure relief device of claim 1, wherein the support strip is arched.

4. The pressure relief device of claim 3, wherein pressure acting on the membrane imparts a compressive force on the support strip.

5. The pressure relief device of claim 3, wherein pressure acting on the membrane imparts a tensile force on the support strip.

6. The pressure relief device of claim 1, wherein the pressure-retaining membrane has a first surface and a second surface, wherein the first surface is configured to face the pressurizable volume, and wherein the support strip is positioned adjacent to the second surface of the membrane.

7. The pressure relief device of claim 1, wherein the pressure-retaining membrane has a first surface and a second surface, wherein the first surface is configured to face the pressurizable volume, and wherein the support strip is positioned adjacent to the first surface of the membrane.

8. The pressure relief device of claim 3, wherein the pressure-retaining membrane is domed.

9. The pressure relief device of claim 1, further comprising a support ring, wherein at least one of the support strip and piercing mechanism is mounted on the support ring.

10. The pressure relief device of claim 1, further comprising a support ring, wherein at least one of the support strip and piercing mechanism is formed integrally with the support ring.

11. The pressure relief device of claim 1, wherein the support strip defines at least one hole, wherein the at least one hole is configured to set the predetermined pressure at which the support strip will deform.

12. The pressure relief device of claim 1, wherein the support strip defines at least one indentation, wherein the at least one indentation is configured to set the predetermined pressure at which the support strip will deform.

13. The pressure relief device of claim 1, wherein the support strip defines at least one notch configured to set the predetermined pressure at which the support strip will deform.

14. The pressure relief device of claim 1, wherein the stress-applying device is a piercing mechanism.

15. The pressure relief device of claim 1, wherein the membrane includes a line of weakness.

16. The pressure relief device of claim 1, wherein the membrane is configured to achieve a minimum net flow area of above 50% after opening.

17. The pressure relief device of claim 1, wherein the membrane is configured to achieve a minimum net flow area of above 60% after opening.

18. The pressure relief device of claim 1, wherein the membrane is configured to achieve a minimum net flow area of above 70% after opening.

19. The pressure relief device of claim 1, wherein the pressure relief device is a battery vent device.

20. The pressure relief device of claim 18, wherein the membrane is gas permeable.

21. A pressure relief device, comprising:
an inlet housing;
a support ring having at least one support strip; and,
a flexible graphite membrane sealed between the inlet housing and support ring, wherein the at least one support strip provides structural support for the flexible graphite membrane;
wherein the flexible graphite membrane is provided with at least one line of weakness.

22. The pressure relief device of claim 21, further comprising a piercing mechanism configured to pierce the flexible graphite membrane.

23. The pressure relief device of claim 21, wherein the at least one support strip is configured to deform in response to a predetermined pressure acting on the flexible graphite member.

24. The pressure relief device of claim 21, wherein the flexible graphite membrane is domed.

25. The pressure relief device of claim 23, wherein the flexible graphite membrane has a center, wherein the dome has an apex offset from the center of the flexible graphite membrane.

26. A pressure relief device, comprising:
a housing;
a piercing mechanism;
a support member comprising a support strip, wherein the piercing mechanism is held between the housing and the support member;
a membrane, wherein the membrane is supported by the support strip; and,
a protective layer, wherein the membrane is held between the support member and the protective layer;
wherein the support strip is configured to fail in response to a predetermined pressure imparted on the support strip via the membrane.
